(19) United States
(12) Patent Application Publication
(10) Pub. No.: US 2026/0300023 A1
(43) Pub. Date: Oct. 1, 2026

(54) SYSTEMS AND METHODS FOR CONFIGURING AND MANAGING KAFKA PLATFORM

(71) Applicant: FMR LLC, Boston, MA (US)

(72) Inventors: Tamal Krishna BHATTACHARYA, Bangalore (IN); Vasan Srini SUNDARRAJAN, Chennai (IN); Jithu BALAKRISHNAN, Chennai (IN); Wayne Buren Scott, III, Aurora, CO (US); Shahriyar Zaman Khan, Irving, TX (US); Robert Charles Bruce, Aurora, CO (US); Praveen Kumar Chowdary Katta, Parker, CO (US)

(21) Appl. No.: 19/089,659

(22) Filed: Mar. 25, 2025

(51) Int. Cl. G06F 9/50; G06F 11/34; G06F 11/3604

(52) U.S. Cl. CPC G06F 9/505; G06F 9/5077; G06F 11/3466; G06F 11/3612; G06F 2209/501

(57) ABSTRACT

Systems and methods are described for configuring and managing Kafka platform. During a development process, predetermined configurations may be provided for the Kafka platform to reduce errors during the development process. Further, during such development process, a producer application may be allocated resources that are provided by a Kafka cluster. Due to the various stages of development in non-production stages (which include testing), the resources allocated to the producer application may change over time. As such, the resources may be scaled before the production stage is entered to accommodate the change in resources allocated during the non-production stages. After entering into production, the user may analyze the capacity of the resources allocated to each producer application. More specifically, a Kafka user interface may display the current capacity of resources allocated to the producer application.

### TECHNICAL FIELD

This application relates generally to systems and methods, including computer program products, for configuring and managing Kafka platform.

### BACKGROUND

In recent years, the Kafka platform has emerged to be a popular platform for storing, processing, and streaming large amounts of data in real-time. For example, known applications of Kafka include providing real-time scores with respect to sporting events (e.g., baseball, basketball, hockey games, etc.), real-time posts on social media platforms, etc. Such popularity arises from the Kafka platform having features such as high throughput, low latency, and scalability. Nevertheless, there are drawbacks to the Kafka platform. First, the number of clusters can be extremely large, thereby making it difficult in managing the resources allocated to an application as well as in monitoring whether the clusters are in danger of failing. Second, the large number of clusters also provides difficulty in troubleshooting when issues arise. It can be difficult to exactly pinpoint where the problem is. Third, users (e.g., IT administrators) may interact with the Kafka platform via a command-line interface. Having a non-visual interface may be problematic because it is difficult to visualize the resource consumption of the clusters. Therefore, errors may go unnoticed due to such lack of visualization.

### SUMMARY

The present disclosure, in another aspect, features a computerized method for automatically managing resources allocated to an application utilizing a Kafka platform, the method comprising: determining, by a server computing device, whether to modify a first amount of resources currently allocated to an application that is to enter production after being subjected to performance testing, the determination being performed by: determining a second amount of resources that were utilized by the application during a previous production; determining a third amount of resources that were utilized by the application during performance testing; and generating a scaling value based on the second amount of resources and the third amount of resources, wherein the scaling value determines a scaling procedure for modifying the first amount of resources, wherein, in case that the scaling value indicates that the first amount of resources is to be increased and then decreased, performing by the server computing device, a first scaling procedure by: increasing the first amount of resources to be equivalent to the third amount of resources; performing a dry-run test to determine whether the execution of the application allocated with the first amount of resources encounters at least one fault; causing the application to enter production after determining that no faults were encountered during the dry-run test; and decreasing the first amount of resources to be equivalent to the second amount of resources.

In case that the scaling value indicates that the first amount of resources is to be increased, performing by the server computing device, a second scaling procedure by: increasing the first amount of resources to be equivalent to the second amount of resources; performing a dry-run test to determine whether the execution of the application allocated with the first amount of resources encounters at least one fault; and causing the application to enter production after determining that no faults were encountered during the dry-run test. In case that the scaling value indicates that the first amount of resources is to be decreased, performing by the server computing device, a third scaling procedure by: performing a dry-run test to determine whether the execution of the application allocated with the first amount of resources encounters at least one fault; causing the application to enter production after determining that no faults were encountered during the dry-run test; and decreasing the first amount of resources to be equivalent to the second amount of resources. In case that the scaling value indicates that the first amount of resources is to remain unmodified, performing by the server computing device, a non-scaling procedure by: performing a dry-run test to determine whether the execution of the application allocated with the first amount of resources encounters at least one fault; and causing the application to enter production after determining that no faults were encountered during the dry-run test.

The Kafka platform comprises a cluster that includes one or more brokers, wherein each broker includes one or more partitions, and wherein at least one of the first amount of resources, the second amount of resources, and the third amount of resources corresponds to at least one partition of the one or more partitions. An initial amount of resources that were allocated for performance testing includes an unused amount of resources that were not utilized during performance testing, and wherein the third amount of resources is generated by removing the unused amount of resources from the initial amount of resources. One or more applications associated with the Kafka platform each include an indicator that indicates whether to remove the unused resources after performance testing has been completed, wherein at least one application of the one or more applications includes a second indicator that indicates that the unused amount of resources is to be removed from the initial amount of resources. At least one application of the one or more applications includes a second indicator that indicates that the initial amount of resources is to remain unmodified after performance testing has been completed, and wherein the third amount of resources is equivalent to the initial amount of resources.

The present disclosure, in another aspect, features a computerized method for preventing errors from occurring in clusters that are associated with a Kafka platform, the system comprising: retrieving, by a server computing device, raw resource data from one or more clusters, wherein each cluster of the one or more clusters includes one or more brokers, wherein the raw resource data includes statistical information regarding the one or more clusters; determining, by the server computing device, for each resource allocated to each cluster of the one or more clusters, utilization rate of the resource, wherein the determination is performed based on the statistical information in the raw resource data retrieved from the one or more clusters; determining, by the server computing device, for each resource allocated to each cluster of the one or more clusters, whether the utilization rate of the resource exceeds one or more predetermined thresholds corresponding to the resource, wherein the one or more predetermined thresholds are ordered by degrees of urgency; generating, by the server computing device, a Hypertext Markup Language (HTML) document object that includes a resource table that represents the one or more clusters, wherein the resource table includes, for each resource of each cluster of the one or more clusters, a utilization rate of the resource, wherein, in a case that the utilization rate reaches at least one predetermined threshold, the utilization rate is color-coded in the resource table according to a color corresponding to the maximum predetermined threshold that was reached, and wherein a timestamp is added to metadata of the resource table to indicate when the raw resource data was retrieved; and displaying, by the server computing device, the resource table on a webpage that has been generated in part by the HTML document object.

For each resource in each cluster of the one or more clusters, an unused amount of the resource is determined after determining the utilization rate of the resource, the unused amount of the resource being determined based on the utilization rate and a total capacity of the resource. The information in the resource table in the raw resource data includes, for each cluster of the one or more clusters, number of applications associated with the cluster, a utilization rate of partitions, a utilization rate of connections, a utilization rate of read operations, a utilization rate of write operations, an unused amount of partitions, an unused amount of connections, an unused amount of read operations, and an unused amount of write operations. The resource table includes a status indicator that indicates the status each cluster of the one or more clusters, wherein the status indicator includes a normal status when the utilization rate of each resource associated with the cluster is less than the corresponding predetermined threshold, and wherein the status indicator includes an alarm status when at least one utilization rate of a resource associated with the cluster reaches at least one of the corresponding one or more predetermined thresholds.

When a utilization rate of a resource associated with the cluster reaches a first predetermined threshold, the status indicator indicates a warning status, which is an alarm status that is color-coded according to a first color. When a utilization rate of a resource associated with the cluster reaches a second predetermined threshold, the status indicator indicates an alert status, which is an alarm status that is color-coded according to a second color, wherein the first color and the second color are different from each other. Updated raw resource data is continuously retrieved from the one or more clusters at a predetermined time interval, such that a new resource table is generated based on the updated raw resource data, and wherein the new resource table is transmitted for display on a webpage. Resources allocated to a cluster includes at least one of partitions, connection capacity, read operation capacity, and write operation capacity.

The present disclosure, in a further aspect, a computerized method for performing configuration during a life cycle development of the Kafka platform to reduce errors during execution, the method comprising: receiving, by a server computing device, a request, from a user of a producer application, to commence a development process on the Kafka platform, wherein the development process includes one or more stages; allocating, by the server computing device, based on the request, a cluster, which includes one or more brokers, wherein each message transmitted by the producer application to the cluster is stored in a leading partition on a corresponding broker of the one or more brokers, and wherein the leading partition generates one or more copies of the message to be stored in one or more contingency partitions; generating, by the server computing device, a Kafka configuration that includes one or more predetermined settings comprising: a first setting that causes the Kafka platform to register a successful write of a message on the cluster when the Kafka platform receives acknowledgement from the leading partition and at least one replica partition; a second setting that causes at least one message to be removed from corresponding leader and contingency partitions after an expiration of a predetermined time period, wherein the predetermined time period commences after the at least one message has already been consumed by each consuming application; and a third setting that manages access control information, wherein the access control information is stored in the Kafka configuration according to a second format and is transformed to a first format when the access control information is requested by the user, the first format being in a human-readable format; and authorizing, by the server computing device, a progression request to progress the development process to a subsequent stage of the one or more stages when the progression request is transmitted by one or more authorized users, wherein the first setting and the second setting are unmodifiable.

The request includes a message template that is in the unescaped JavaScript Object Notation (JSON), the message template being associated with a structure of each message produced and consumed on the Kafka platform. The computerized method further comprising: receiving, by the server computing device, a message template from the user in request, the message template being in an unescaped JavaScript Object Notation (JSON) format; transforming, by the server computing device, a message template from the unescaped JSON format into an escaped schema format; and transmitting, by the server computing device, the transformed message template to a schema registry. The computerized method further comprising: generating, by the server computing device, a subject identifier for the message template based on a topic identifier associated with each message, wherein the user is restricted from modifying the subject identifier. The computerized method further comprising: transmitting, by the server computing device, the access control information after receiving a request for the access control information from the user, wherein the access control information is transmitted to the user in the second format; receiving, by the server computing device, a modified access control information from the user, wherein the modified access control information includes one or more modifications to the access control information; and transforming, by the server computing device, the modified access control information from the second format into the first format. The access control information is transmitted to be displayed on a user interface, and wherein the user modifies the access control information to generate the modified access control information via the user interface. The access control information corresponds to one or more permissions granted to at least one of the producer application, one or more subjects, and one or more consumer devices. The access control information indicates one or more authorized users that are allowed to cause the progression of the development process to progress from one stage to another stage.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a Kafka system.

FIG. 2 is a flow diagram of a computerized method for managing resources allocated to a producer application.

FIGS. 3A-3D are example diagrams illustrating tables describing how scaling values are determined based on the resources allocated to the producer application during performance testing and the resources currently allocated to producer application.

FIG. 4 is a flow diagram of a computerized method for executing a split-scaling procedure.

FIG. 5 is a flow diagram of a computerized method for executing a scale-up procedure.

FIG. 6 is a flow diagram of a computerized method for executing a scale-down procedure.

FIG. 7 is a flow diagram of a computerized method for performing configuration during Kafka development process.

FIG. 8A is an example diagram illustrating a message template (e.g., schema) that is in the unescaped JSON (JavaScript Object Notation) format.

FIG. 8B is an example diagram illustrating a message template (e.g., schema) that is in the escaped JSON format.

FIG. 9A is an example diagram illustrating access control information that is in a second format.

FIG. 9B is an example diagram illustrating a Kafka user interface that is displayed before a user, in which the Kafka user interface includes an information interface currently displaying access control information that is in a first format (e.g., human-readable).

FIG. 10 is a flow diagram of a computerized method for detecting failures in a Kafka clusters.

FIG. 11 is an example diagram illustrating is an example diagram illustrating a Kafka user interface that is displayed before a user (e.g., displayed on a web page via web browser), in which the Kafka user interface includes a cluster capacity report in the form of a table.

FIG. 12 is a diagram of an illustrative computing system.

### DETAILED DESCRIPTION

In describing preferred embodiments illustrated in the drawings, specific terminology is employed herein for the sake of clarity. However, this disclosure is not intended to be limited to the specific terminology so selected and it is to be understood that each specific element includes all technical equivalents that operate in a similar manner. In addition, a detailed description of known functions and configurations is omitted from this specification when it may obscure the inventive aspects described herein.

Various tools are discussed herein to facilitate the invention(s) disclosed herein. It should be appreciated by those skilled in the art that any one or more of such tools may be embedded in the application and/or in any of various other ways, and thus while various examples are discussed herein, the inventive aspects of this disclosure are not limited to such examples described herein.

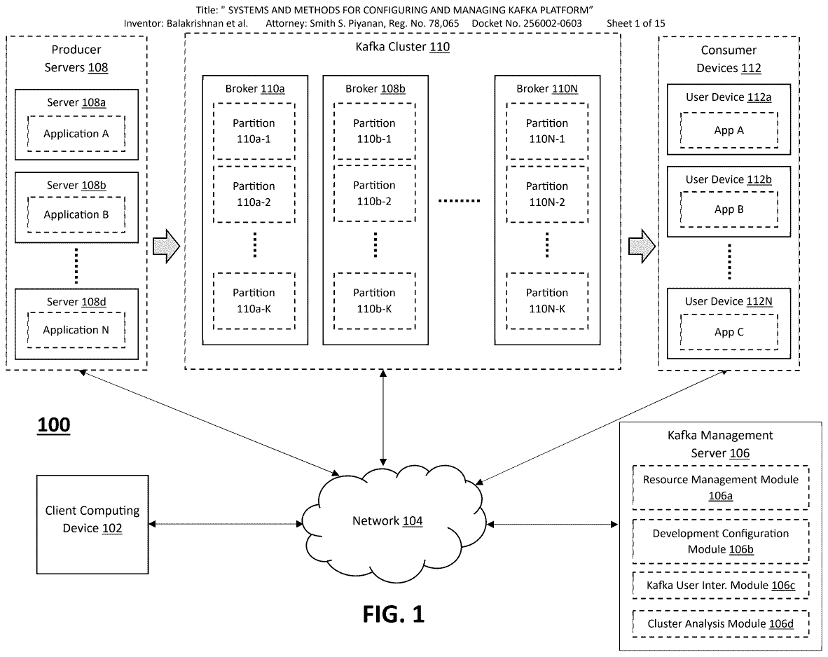

FIG. 1 is a block diagram of a system for 100, which includes a client computing device 102, a Kafka management server 106, producer servers 108, a Kafka cluster 110, and consumer devices 112, all of which are capable of communicating with each other via a communication network 104.

The client computing device 102 can be coupled to a display device (not shown), such as a monitor, display panel, or screen. For example, client computing device 102 can provide a graphical user interface (GUI) via the display device to a user of corresponding device that presents output resulting from the methods and systems described herein and receives input from the user for further processing. Further, the client computing device 102, may include one or more applications that provide additional functionality to the client computing device 102. For example, the client computing device 102 may include a browser application that allows access to the services provided by devices on system 100, via a website, which can be reached by entering a uniform resource locator (URL). Exemplary client computing device 102 include but is not limited to desktop computers, laptop computers, tablets, mobile devices, smartphones, smart watches, Internet-of-Things (IOT) devices, and internet appliances. It should be appreciated that other types of client computing devices that are capable of connecting to components of the system 100 can be used without departing from the scope of invention. Although FIG. 1 depicts a single client computing device 102, it should be appreciated that system 100 can include any number of client computing devices 102.

The communication network 104 can be a local area network, a wide area network, a cellular network, or any type of network such as an intranet, an extranet (for example, to provide controlled access to external users, for example through the Internet), a private or public cloud network, the Internet, etc., or a combination thereof. In addition, the communication network 104 preferably uses TCP/IP (Transmission Control Protocol/Internet Protocol), but other protocols such as SNMP (Simple Network Management Protocol) and HTTP (Hypertext Transfer Protocol) can also be used. In some embodiments, the communication network 104 is comprised of several discrete networks and/or sub-networks (e.g., cellular to Internet).

The Kafka management server 106 is a device (e.g., server computing device) including specialized hardware and/or software modules that execute on a processor and interact with memory modules of the Kafka management server 106, to transmit data to other components of the system 106, and to receive data from other components of the system 100, as described herein. The Kafka management server 106 includes several systems, frameworks, stores, and computing modules that execute on one or more processors of the Kafka management server 106. For example, the Kafka management server 106 includes a resource management module 106a, a development configuration module 106b, a Kafka user interface module 106c, and a cluster analysis module 106d. In some embodiments, the resource management module 106a, the development configuration module 106b, the Kafka user interface module 106c, and the cluster analysis module 106d are specialized sets of computer software instructions programmed onto one or more dedicated processors in the Kafka management server 106 and can include specifically-designated memory locations and/or registers for executing the specialized computer software instructions.

Although the resource management module 106a, the development configuration module 106b, the Kafka user interface module 106c, and the cluster analysis module 106d are shown in FIG. 1 as executing within the Kafka management server 106, in some embodiments the functionality of the resource management module 106a, the development configuration module 106b, the Kafka user interface module 106c, and the cluster analysis module 106d can be distributed among a plurality of server computing devices. As shown in FIG. 1, the Kafka management server 106 allows the resource management module 106a, the development configuration module 106b, the Kafka user interface module 106c, and the cluster analysis module 106d to communicate with each other in order to exchange data for the purpose of performing the described functions.

It should be appreciated that any number of computing devices, arranged in a variety of architectures, resources, and configurations (e.g., cluster computing, visual computing, cloud computing) can be used without departing from the scope of the invention. Exemplary functionality of the resource management module 106a, the development configuration module 106b, the Kafka user interface module 106c, and the cluster analysis module 106d are described in detail below.

The producer servers 110 may include one or more servers (e.g., server computing device) 110a-110N (where server 110N represents a final item (e.g., server) of the producer servers 110, in which there may be an arbitrary number of servers). In turn, the one or more servers 110a-110N includes one or more applications A-N (where application N represents a final item (e.g., application) of the one or more applications A-N, in which there may be an arbitrary number of applications). Each of the applications A-N on the producer servers 110 may transmit event data (e.g., publish or write) to the Kafka cluster 108. The event data may include one or more record items (e.g., messages) that each represent a single event. More specifically, the event data may correspond to one or more events that have occurred. For example, the application may monitor patients in hospital care with the event data corresponding to changes in the condition of the patients. In another example, the application may keep track of scoring in a sports game (e.g., hockey, basketball, etc.) with the event data corresponding to changes in scoring throughout the game (e.g., a first record item may correspond to the score 0-0, but a second record item (immediately subsequent to the first record item) may correspond to the score 0-1. Consequently, whenever there is a new (or updated) event, the application may cause the producer servers 110 to transmit a new record item to the Kafka cluster 110.

The Kafka cluster 110 may include one or more brokers 110a-110N (where broker 110N represents a final item (e.g., server) of the producer servers 110, in which there may be an arbitrary number of servers) that each include one or more partitions. As shown, broker 110a includes partitions 110a-1 to 110a-K, broker 110b includes partitions 110b-1 to 110b-K, and broker 110N includes partitions 110N-1 to 110N-K (where K is a positive integer). Each partition in the Kafka cluster 110 may correspond to a topic. A topic may be generated to categorize the event data. For example, topics, in connection with an Internet-of-Things (IOT) application, may include (but is not limited to) sensor readings, sensor updates, device alerts, etc. In another example, topics, connection with an e-commerce application may include (but is not limited to) product orders, shipping status, shopping cart updates, etc. It should be noted that different partitions in different brokers 110a-110N may correspond to a topic. For example, a first set of partitions (e.g., partitions 110a-1, 110b-2, 110b-3, and 110N-K) may correspond to a first topic, while a second set of partitions (e.g., partitions 110a-1 and 110b-1) may correspond to a second topic.

In some embodiments, one or more partitions may be used as replicas for a leading partition. More specifically, a leading (e.g., main) partition may receive the one or more record items from the producer servers. After receiving such one or more record items, the leading partition may generate a duplicate (e.g., a copy) of the received one or more record items for each associated replica partition (e.g., may be disposed of in different brokers from the leading partition). The leading partition may transmit such duplicates to the proper replica partition. Such duplication is advantageous in case that leading partition or broker is down (e.g., crashes), the record items are still stored in other locations.

Further, each partition (e.g., partitions 110a-1 to 110a-K, partitions 110b-1 to 110b-K, partitions 110N-1 to 110N-K) includes (e.g., stores) one or more record items that are associated with the topic corresponding to the partition. Each record item may include an event key that determines in which partition that the record item should be included (e.g., stored). For example, the application (e.g., A, B, or C) may assign an event key to the record time after the record item has been generated. In addition, each record item may be associated with an (unique) offset value that identifies the position of the record item in the partition. It should be noted that, in some embodiments, the record items in the partitions may not necessarily be deleted after being read by a user device (of the user devices 112a-112N). In other words, the record items may be stored for a long period of time or permanently.

In other words, the event data generated by an application (e.g., A, B, or C) may be divided (or grouped) according to a topic. Further, the topics may each be divided into one or more partitions. In turn, each partition of the one or more partitions may include one or more record items that are each included in the proper partition (e.g., by a broker) based on the event key included in the record item. The one or more record items are stored in the proper partition (e.g., via appending) such that the one or more record items are in a consecutive order (e.g., based on the time in which the record items arrive at the proper partition) with each record item being identified in the proper partition based on an offset value.

The consumer devices 112 may include one or more user devices 112a-112N (where user device 112N represents a final item (e.g., user device) of the consumer devices 112, in which there may be an arbitrary number of user devices). Each of the user devices 112a-112N may be a client computing device (e.g., client computing device 102). Exemplary user devices 112a-112N include but is not limited to desktop computers, laptop computers, tablets, mobile devices, smartphones, smart watches, Internet-of-Things (IOT) devices, and internet appliances. A user device (of the user devices 112a-112N) can be coupled to a display device (not shown), such as a monitor, display panel, or screen. For example, such user device can provide a graphical user interface (GUI) via the display device to a user of corresponding device that presents output resulting from the methods and systems described herein and receives input from the user for further processing. Further, the user device may include one or more apps (e.g., software applications) that provide additional functionality to the user device. More specifically, each of the user devices 112a-112N includes one or more apps A-N (where app N represents a final item (e.g., app) of the one or more apps A-N, in which there may be an arbitrary number of apps).

The one or more apps A-N may be associated with the one or more applications A-N. More specifically, the apps A-N allow a user to view the record data stored on the Kafka cluster 110. To facilitate such action, the apps A-N are configured to subscribe or continuously receive one or more record items that correspond to one or more topics until there are no more record items in the topic. For example, the application A may be an application that provides hockey scores corresponding to one or more matches in a tournament, in which the application continuously transmits updates to the hockey scores for individual matches (via the Kafka cluster 110) to the App A of the user device 112a. The application may cease transmission of such updates when the match ends (e.g., there is a winner). Further, as discussed previously, the one or more record items are stored in the proper partition (e.g., via appending) such that the one or more record items are in a consecutive order (e.g., based on the time in which the record items arrive at the proper partition). Consequently, the transmission of the record items (e.g., hockey scores) may be made in sequence (e.g., the earlier match scores are transmitted before later match scores).

In addition, it should be noted that one or more user devices 112a-112N may receive record items from the same partition. Since the one or more user devices 112a-112N may receive different record items at different times (e.g., a user may turn off the user device 112a for charging, while another user may keep the user device 112b turned on), the one or more user devices 112a-112N may monitor which record item was received based on the offset value of the record. More specifically, the one or more user devices 112a-112N may maintain an offset tracker that corresponds to the offset value of the most recent record item received. This allows each of the one or more user devices 112a-112N keep track of which record items were already received.

In a further example, application A may produce event data corresponding to tennis tournaments. As such, topics may include one or more tournaments such as Wimbledon, U.S. Open, French Open, etc. The topic may be divided into partitions such as individual matches (between players) within the tournament. In other words, the partitions represent a particular match (e.g., Roger Federer vs. Andy Roddick, Rafael Nadal vs. Novak Djokovic, etc.). The partitions may be further divided into record items, such as the current score in a particular match (e.g., Roger Federer: 5 vs. Andy Roddick: 4). The one or more producer servers associated with the application A may transmit the current score to a corresponding partition within a broker of a Kafka cluster. In turn, a user device having the app A (corresponding to the application A) may receive the current score and display it before the user of the user device having app A. Whenever the score changes, a record item having the update score is generated and transmitted to the Kafka cluster (e.g., Roger Federer: 6 vs. Andy Roddick: 4).

### Example Routine for Managing Resources Allocated to Application

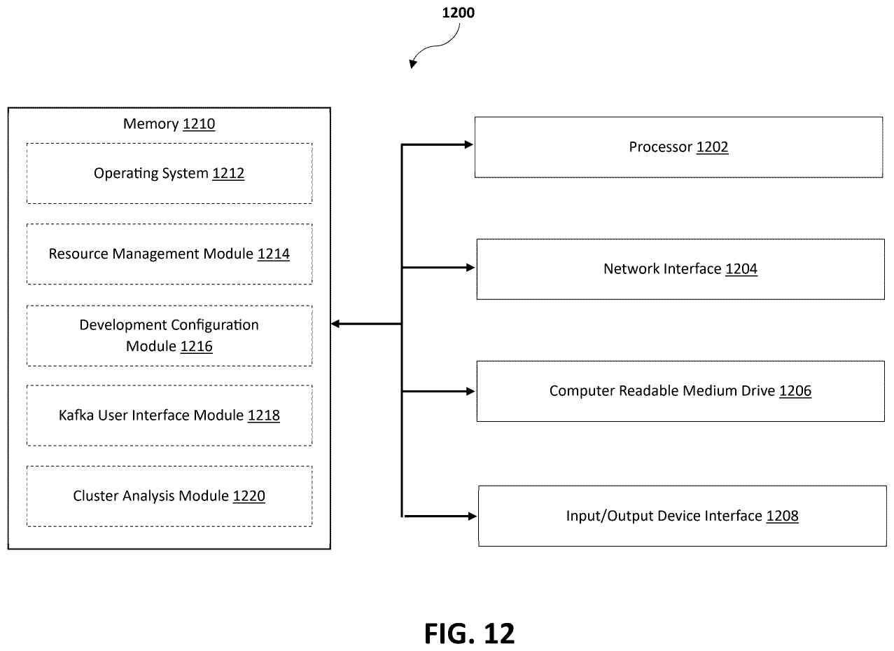

When a routine described herein (i.e., 200, 300, 400, 500, 600, 700, 1000) is initiated, as set of executable program instructions stored on one or more non-transitory computer-readable media (e.g., hard drive, flash memory, removable media, etc.) may be loaded into memory (e.g., random access memory or RAM) of a computing device, such as the computing device 1200 shown in FIG. 12, and executed by one or more processors. In some embodiments, the routine 200, 300, 400, 500, 600, 700, 1000 or portions thereof may be implemented on multiple processors, serially or in parallel.

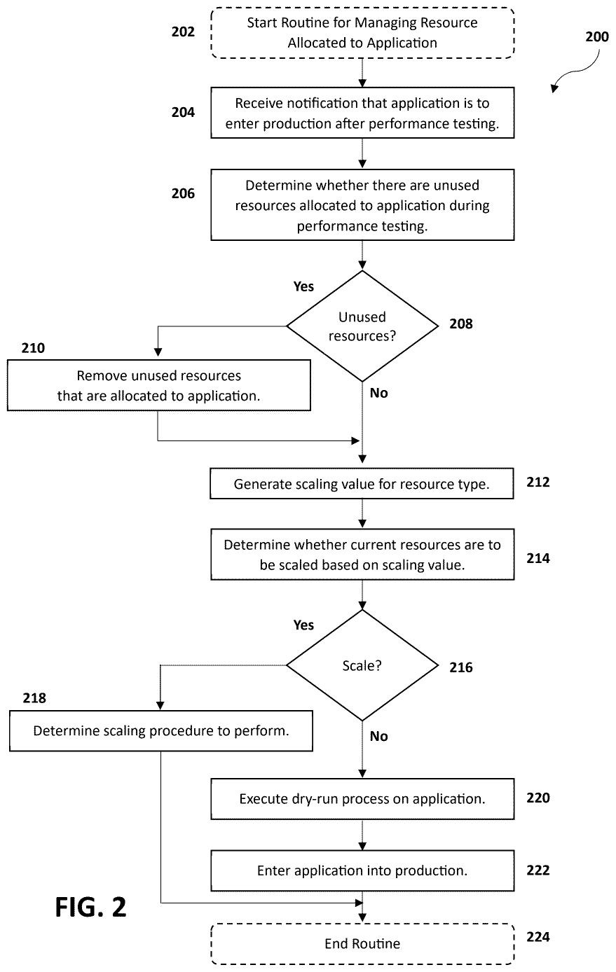

FIG. 2 illustrates example routine 200 (beginning at block 202) for managing resources allocated to an application, that is performed, for example, by at least the resource management module 106a. At block 204, the resource management module 106a may receive a notification that the application is to enter production after non-production. In other words, when an application is being developed (e.g., created) or updated, the application may undergo one or more stages in the software development process (or lifecycle). The software development process may include a production stage and a non-production stage.

The production stage is when the application is deployed in a live environment for use by end-users (e.g., customers). The application may host real-world operations and may handle sensitive data. More specifically, during production, the application is operating in the “real-world” in which the application provides real (e.g., actual) data to the Kafka cluster 110, which transmits such data to each of user devices 112a-112N. The non-production stage is when the application is being developed, tested, and staged in one or more non-production environments. Such non-production environments may be isolated from the live environment and may use dummy or anonymized data to avoid compromising real-world operations. In some embodiments, the application may be simultaneously deployed in a live environment and a copy of the application may undergo development in a non-production environment (e.g., for updating the application). In other words, this may avoid interruption of services provided by the application.

The non-production stage may include one or more stages. Examples of non-production stages include, but are not limited to, the development stage and the testing stage. In the (code) development stage, developers of the application may write, edit, and test code. For example, the code development stage may be where the code for the application is first written. In another example, the application has already been created, tested, and entered into production. As such, in the case of an existing application, the development stage is where developers may update the existing application by writing new code, editing existing code, and testing the new or modified code in the application.

The testing stage may allow for validating software functionality, performance, and compatibility of a system or an application. The testing stage may include various types of testing such as, but not limited to, unit testing, system integration testing, performance testing, and user acceptance testing. The unit testing may include testing individual components or modules for accuracy. The system integrating testing may ensure that different components of the application work together as expected. The user acceptance testing may allow end-users or stakeholders to validate the performance of the application against one or more conditions (e.g., requirements). The user acceptance testing may allow end-users or stakeholders to validate the performance of the application against one or more conditions (e.g., requirements). The performance testing stage may involve evaluating the performance and/or scalability of a system or application. More details regarding performance testing are discussed below.

In some embodiments, the process of moving the application through the non-production stages is sequential, in which the sequence includes the following order: development stage then testing stage. In some embodiments the process of moving the application through each stage in the testing stage is sequential, in which the sequence includes the following order: unit testing stage, system integration testing stage, user acceptance testing stage, and performance testing stage. It should be noted that the stages in the testing stage can be performed in any order and is not limited to the aforementioned sequence.

As discussed above, the application may be subjected to performance testing. The performance testing may include performing one or more types of performance tests on the application or system. Such performance tests may include load testing (e.g., simulates a real-world load on the application or system to determine how it performs under stress), stress testing (e.g., tests the system's ability to handle a high load above normal usage levels), scalability testing (e.g., effectiveness is determined by scaling up to support an increase in user load), and endurance testing (e.g., evaluating the ability of an application or system to handle a constant load). In some embodiments, performance testing may involve having the producer servers (e.g., producer servers 108) transmit dummy data to one or more brokers (e.g., brokers 110a-110N) of a Kafka cluster (e.g., Kafka cluster 108), which in turn transmit the dummy data to simulated user devices. The dummy data may be fabricated data that is configured to be similar to (or behave like) real-world data. Likewise, the simulated user devices are also configured to be similar to (or behave like) real-world user devices. Further, during production or performance testing, the application may be allocated resources that are provided by the Kafka cluster 110. For example, the resources may include, but are not limited to, partitions, the number of writes (e.g., writes to partitions), the number of reads (e.g., reads of partitions), and the number for free connections (e.g., TCP connections established by the producer applications or the consumer apps to the brokers) in the Kafka cluster 110.

Such performance testing may be performed to determine the performance levels (or scalability) of at least one of the applications A-N, the servers 108b-108d of the producer servers 108, and the brokers 110a-110N in the Kafka cluster 110. For example, one of the applications A-N may receive a (major) update (e.g., new code being written to add a new feature or configuration). In such case, the administrators (e.g., IT administrator) may wish to test the performance of the application in view of this new update. In another example, the application may be scheduled to handle (e.g., processing, or providing) more data (e.g., the application previously provides scoring data for domestic sports games, but now additionally provides scoring data for international sports games as well). Similarly, the administrator may wish to determine how well the application can handle the increase in data. As such, the routine 200 may be performed after the performance testing has ended and/or the application is deemed ready to move to (e.g., enter) production.

At block 206, the resource management module 106a may determine whether there are unused resources that were allocated to the application during performance testing. More specifically, the application may have been allocated more resources than during the previous production (e.g., production before the performance testing). For example, as discussed previously, the application may be scheduled to handle an increase in the amount of data (e.g., additional international sports games). As such, the resources allocated in the previous production (e.g., domestic sports games only) may not be enough to allow the increase in data (e.g., additional internation sports games). Therefore, it is natural to allocate more resources to the application to handle such increase. Nevertheless, it may be difficult to determine the exact amount of resources to allocate (e.g., the administrator may make an estimate or educated guess based on other data and statistics). As a result, it may be more practical to allocate more resources than needed (based on the estimate) to the application.

In the case that there are no unused resources (block 208, no), the routine 200 moves to block 212. On the other hand, in the case that there are unused resources (block 210, yes), the resource management module 106a removes unused resources that were allocated to the application. For example, the resource management module 106a may first determine the resources that were utilized during performance testing and determine the total resources allocated during performance testing. Then, the resource management module 106a may determine the unused resources based on the difference between the aforementioned total resources and the resources that were utilized during performance testing.

At block 212, the resource management module 106a generates a scaling value for each resource type. More specifically, the scaling value is used by the resource management module 106a to determine whether to increase or decrease the (first) amount of resources that are currently allocated to the application based on a second amount of resources that were utilized by the application during performance testing (e.g., testing how well the Kafka cluster can handle data from both domestic and international sport games). For example, the resources may include, but are not limited to, partitions, the write capacity, the read capacity, and connections (e.g., TCP connections established by the producer applications or the consumer apps to the brokers) in the Kafka cluster 110.

The current amount of resources currently allocated to the application may have been allocated during a previous production. In some embodiments, there may be a predetermined amount of resources that are allocated to applications that are in the production stage. As such, the current amount of resources may be equivalent to such predetermined amount of resources. For example, such resources may be associated with a production namespace, which may be a dedicated cluster (e.g., Kafka cluster 100) that is specifically configured to run applications in the production stage. In some embodiments, the current amount of resources are allocated after performance testing ends (e.g., after completion of the performance testing stage).

In other embodiments, the current amount of resources may be equivalent to the amount of resource that were allocated in a previous production. For example, as discussed previously, the previous production may include having the application provide data for domestic sport games to one or more user devices via the Kafka cluster. The performance testing may be performed after the previous production to determine the performance levels of the Kafka cluster when the Kafka cluster is provided with more data. Such performance testing may be facilitated using dummy data that is configured to be similar to data for international sports games and simulated user devices that are configured to be similar to real-world user devices.

Further, as discussed previously, there may be more than one resource type that is included within a Kafka cluster (e.g., partition, the write capacity, the read capacity, and connections). As such, a scaling value is generated for each resource type that is included within the Kafka cluster. In other words, there may be multiple scaling values (e.g., partition scaling value, write scaling value, read scaling value, connections scaling value, etc.). In some embodiments, the quantity associated with each resource type is represented as a numerical (e.g., integer or decimal) value (e.g., partitions: 764; connections: 10,658; reads: 165,554). As such, each scaling value may be the difference of the quantity of each resource type (e.g., the resource type for the current amount of resources subtracted from the resource type for the amount of resources allocated during performance testing).

For example, the quantity of a read resource type for the current amount of resources may be 1,000 and the quantity of a read resource type for the amount of resources allocated during performance testing may be 300. As such, the read scaling value may be −700 (e.g., a negative number). In another example, the quantity of a write resource type for the current amount of resources may be 32 and the quantity of a write resource type for the amount of resources allocated during performance testing may be 99. As such, the read scaling value may be 67 (e.g., a positive number).

At block 214, the resource management module 106a determines whether the current resources are to be scaled based on the scaling values. Such determination may be made based on the scaling values. For example, in case that at least one of the scaling values (e.g., partition scaling value, write scaling value, read scaling value, connections scaling value, etc.) is unequal to zero (e.g., the current amount of resources is not equivalent to the amount of resources allocated during performance testing with respect to at least one resource type), then the resource management module 106a may determine that scaling is to be performed. In another example, in case that each scaling value (e.g., partition scaling value, write scaling value, read scaling value, connections scaling value, etc.) is equal to zero (e.g., the current amount of resources is equivalent to the amount of resources allocated during performance testing), the resource management module 106a may determine that scaling is not to be performed.

In case the current resources are to be scaled, the routine moves to block 218. At block 218, the resource management module 106a determines the scaling procedure to perform based on the one or more scaling values. More specifically, the resource management module 106a may perform at least one of a split-scaling procedure, a scale-up procedure, and a scale-down procedure. In some embodiments, the sign (e.g., positive of negative) of the scaling values determine which of the aforementioned scaling procedures is to be performed (e.g., zero may not be considered a positive or negative number).

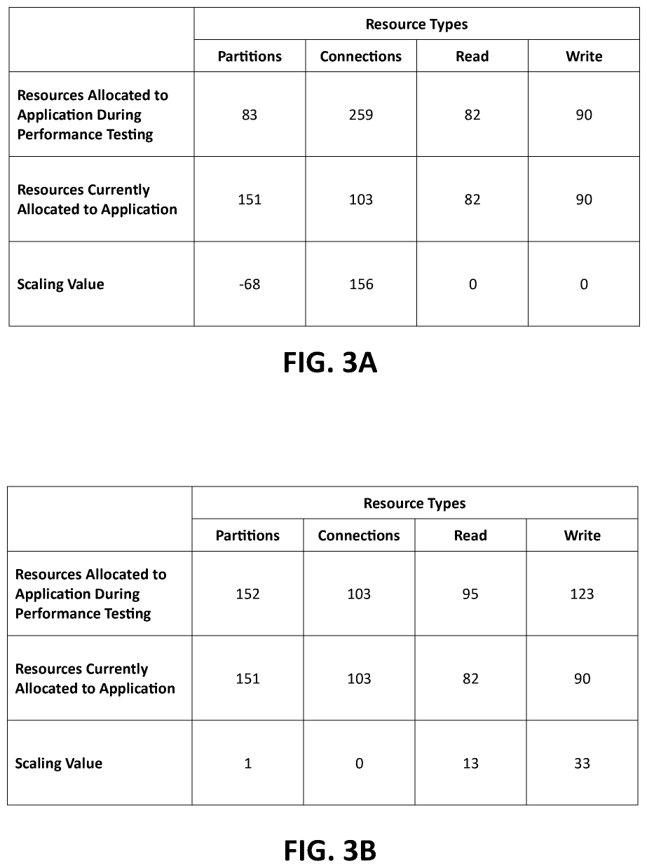

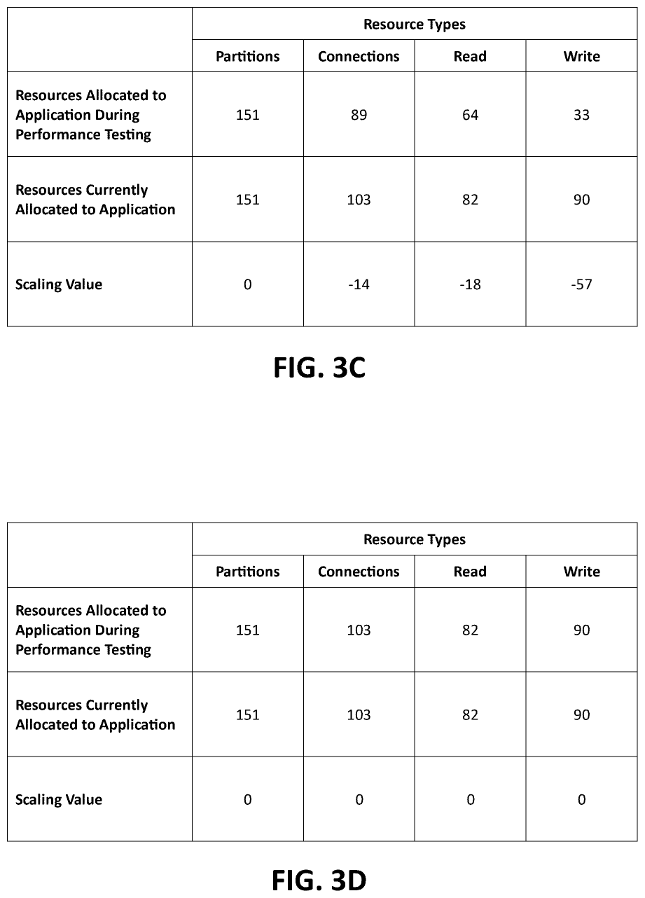

In the case that the resource management module 106a determines that at least one of the resource types is to increase (e.g., a scaling value having a positive sign) and at least one of the resource types is to decrease (e.g., a scaling value having a negative value), the resource management module 106a determines that a split-scaling procedure is to be performed. An example of the determination of a split-scaling procedure is shown via a table that is illustrated in FIG. 3A. The table includes the resource types corresponding to the resources allocated to the application during performance testing (e.g., partitions: 83; connections: 259; read: 82; write: 90) and the resources currently allocated to the application (e.g., partitions: 151; connections: 103; read: 82; write: 90). The table also includes scaling values for each resource type (e.g., partition scaling value: −68; connection scaling value: 156; read scaling value: 0; write scaling value: 0). As discussed previously, each of the scaling values are determined based on the difference between the resources allocated to application during performance testing (e.g., second amount of resources) and the resources currently allocated to application (e.g., first amount of resources). For example, the scaling value may be determined by subtracting the first amount of resources from the second amount of resources (e.g., partition scaling value: −68=83−151; connection scaling value: 156=259−103; read scaling value: 0=82−82; write scaling value: 0=90−90). More specifically, there is at least one scaling value that includes a positive sign (i.e., connection scaling value: 156) and at least one scaling value that includes a negative sign (i.e., partition scaling value: −68). As a result, such scaling values (e.g., having a positive sign and a negative sign) indicate that a split-scaling procedure is to be performed.

In the case that the resource management module 106a determines that at least one of the resource types is to be increased (e.g., a scaling value having a positive sign) and none of the remaining resource types are to be increased or decreased (e.g., a scaling value equal to zero), the resource management module 106a determines that a scale-up procedure is to be performed. An example of the determination of a scale-up procedure is shown via a table that is illustrated in FIG. 3B. The table includes the resource types corresponding to the resources allocated to the application during performance testing (e.g., partitions: 152; connections: 103; read: 95; write: 123) and the resources currently allocated to the application (e.g., partitions: 151; connections: 103; read: 82; write: 90). The table also includes scaling values for each resource type (e.g., partition scaling value: 1; connection scaling value: 0; read scaling value: 13; write scaling value: 33). As discussed previously, each of the scaling values are determined based on the difference between the resources allocated to application during performance testing (e.g., second amount of resources) and the resources currently allocated to application (e.g., first amount of resources). For example, the scaling value may be determined by subtracting the first amount of resources from the second amount of resources (e.g., partition scaling value: 1=152-151; connection scaling value: 0=103-103; read scaling value: 13=95-82; write scaling value: 33=123-90). More specifically, there is at least one scaling value that includes a positive sign (i.e., partition scaling value: 1; read scaling value: 13; write scaling value: 33) and no scaling value that includes a negative sign. As a result, such scaling values (e.g., having a positive sign but no negative signs) indicate that a scale-up procedure is to be performed.

In the case that the resource management module 106a determines that at least one of the resource types is to be decreased (e.g., a scaling value having a negative sign) and none of the remaining resource types are to be increased or decreased (e.g., a scaling value equal to zero), the resource management module 106a determines that a scale-down procedure is to be performed. An example of the determination of a scale-down procedure is shown via a table that is illustrated in FIG. 3C. The table includes the resource types corresponding to the resources allocated to the application during performance testing (e.g., partitions: 151; connections: 89; read: 64; write: 33) and the resources currently allocated to the application (e.g., partitions: 151; connections: 103; read: 82; write: 90). The table also includes scaling values for each resource type (e.g., partition scaling value: 0; connection scaling value: −14; read scaling value: −18; write scaling value: −57). As discussed previously, each of the scaling values are determined based on the difference between the resources allocated to application during performance testing (e.g., second amount of resources) and the resources currently allocated to application (e.g., first amount of resources). For example, the scaling value may be determined by subtracting the first amount of resources from the second amount of resources (e.g., partition scaling value: 0=151-151; connection scaling value: −14=89-103; read scaling value: −18=64-82; write scaling value: −57=33-90). More specifically, there is at least one scaling value that includes a negative sign (i.e., connection scaling value: −14; read scaling value: −18; write scaling value: −57) and no scaling value that includes a positive sign. As a result, such scaling values (e.g., having a negative sign but no positive signs) indicate that a scale-down procedure is to be performed.

In the case that the current resources are not to be scaled, the routine moves to block 220. In other words, the resource management module 106a may determine that no scaling procedure is to be performed (e.g., split-scaling, scale-up, scale-down). An example of the determination of that no scaling procedure is to be executed is shown via a table that is illustrated in FIG. 3D. The table includes the resource types corresponding to the resources allocated to the application during performance testing (e.g., partitions: 151; connections: 103; read: 82; write: 90) and the resources currently allocated to the application (e.g., partitions: 151; connections: 103; read: 82; write: 90). The table also includes scaling values for each resource type (e.g., partition scaling value: 0; connection scaling value: 0; read scaling value: 0; write scaling value: 0). As discussed previously, each of the scaling values are determined based on the difference between the resources allocated to application during performance testing (e.g., second amount of resources) and the resources currently allocated to application (e.g., first amount of resources). For example, the scaling value may be determined by subtracting the first amount of resources from the second amount of resources (e.g., partition scaling value: 0=151-151; connection scaling value: 0=103-103; read scaling value: 0=82-82; write scaling value: 0=90-90). More specifically, there are no scaling values that include a positive or a negative sign. In other words, each (e.g., every) scaling value is equal to zero. As a result, such scaling values (e.g., having zero as a value) indicate that no scaling procedure is to be performed.

At block 220, a dry-run is executed. A dry-run may be a process (e.g., software testing process) to ensure that the system is operating correctly (e.g., does not result in severe failure). For example, a dry-run may allow a user (e.g., a person performing testing) to be informed on (or view) the operations that would be performed by the Kafka cluster without actually executing such operations. At block 222, the application is entered into production. The routine ends at block 224.

### Example Routine for Executing Split-Scaling Procedure

When a routine described herein (i.e., 200, 300, 400, 500, 600, 700, 1000) is initiated, as set of executable program instructions stored on one or more non-transitory computer-readable media (e.g., hard drive, flash memory, removable media, etc.) may be loaded into memory (e.g., random access memory or RAM) of a computing device, such as the computing device 1200 shown in FIG. 12, and executed by one or more processors. In some embodiments, the routine 200, 300, 400, 500, 600, 700, 1000 or portions thereof may be implemented on multiple processors, serially or in parallel.

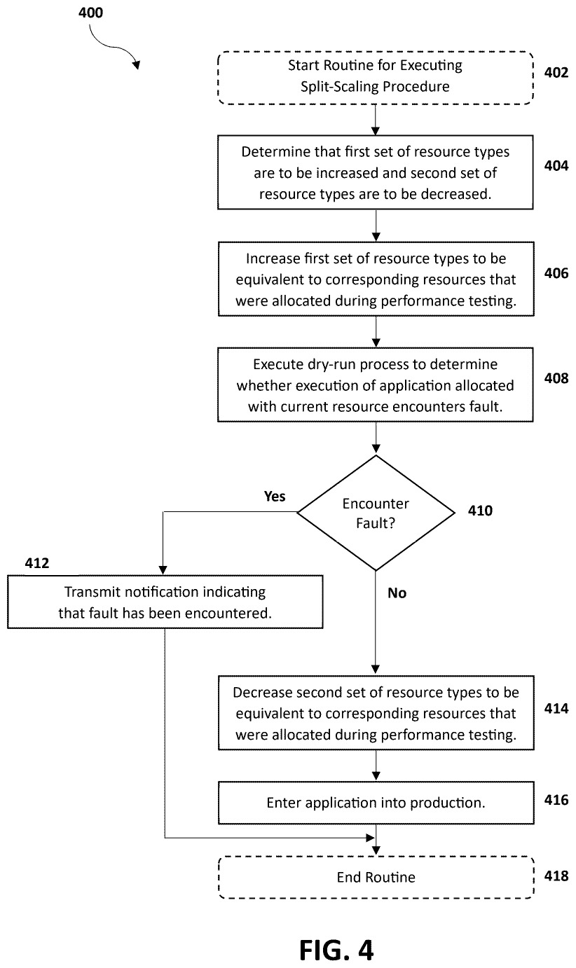

FIG. 4 illustrates example routine 400 (beginning at block 402) for executing a split-scaling procedure, that is performed, for example, by at least the resource management module 106a. At block 404, the resource management module 106a determines that a first set of resource types are to be increased and a second set of resource types are to be decreased. As discussed previously with respect to routine 200 in FIG. 2, the resource management module 106a may determine one or more scaling values based on the current resources allocated to the application and the resources allocated to the application during performance testing. The one or more scaling values indicate whether to increase, decrease, or maintain (e.g., keep the same) the current amount of resources (e.g., resource types) provided by the Kafka cluster (e.g., block 212 of routine 200 in FIG. 2) to the application. After determining the scaling values, the resource management module 106a determines the scaling procedure based on the one or more scaling values (e.g., block 218 of routine 200 in FIG. 2).

In case that a first set of scaling values (e.g., including a subset of the one or more scaling values) indicate that one or more resource types are to be increased (e.g., first set of resource types) and a second set of scaling values (e.g., including a subset of the one or more scaling values) indicate that one or more resource types are to be increased (e.g., second set of resource types), the resource management module 106a determines that a split-scaling procedure is to be performed (or executed). It should also be noted that there may be a third set of scaling values (e.g., including a subset of the one or more scaling values) that indicates that one or more resource types are to be maintained (e.g., remain the same without any increase or decrease). However, the existence of such third set of scaling values may not affect the determination of the performance of the split-scaling procedure.

For example, with respect to the example illustrated in FIG. 3A, there is one resource type (e.g., connections) associated with a scaling value that includes a positive sign (e.g., indicating an increase) and one resource type (e.g., partitions) associated with a scaling value that includes a negative sign (e.g., indicating decrease). As such, the resource type associated with connections is included in the first set of resource types, while the resource type associated with partitions is included in the second set of resource types. Further, there are two resources (e.g., read and write) that have scaling values that are equal to zero, which indicates that such resource types (e.g., read and write) are not to be increased or decreased.

At block 406, the resource management module 106a increases the first set of resource types to be equivalent to corresponding resources that were allocated during performance testing. For example, as discussed previously with respect to the example illustrated in FIG. 3A, the connections resource type is included in the first set of resource types. Thus, the connections resource type is increased from 103 to 259. It should be noted that, while the example in FIG. 3A indicates that a single resource type is to be increased, this may not necessarily always be the case. In other words, in case that the scaling values for the remaining resource types (other than the resource types in the second set of resource types), such as read and write, are associated with scaling value having a positive sign, such resource types may also be included in the first set of resources (and therefore be increased).

At block 408, the resource management module 106a executes a dry-run process to determine whether the execution of the application allocated with the current resource encounters one or more faults. As discussed previously, a dry-run may be a process (e.g., software testing process) to ensure that the system is operating correctly (e.g., does not result in severe failure). For example, a dry-run may allow a user (e.g., a person performing testing) to be informed on (or view) the operations that would be performed by the Kafka cluster without actually executing such operations. It should also be noted that, before the execution of the dry-run process, the application may still be allocated with the same current resources (e.g., partitions: 151; read: 82; write: 90) with the exception of the resource types included in the first set of resource types (e.g., connections: 103→259), which are, instead, increased to be the same value as in the resources allocated to application during performance testing. As such, the current resources allocated to the application at block 406 (e.g., partitions: 151; connections: 259; read: 82; write: 90) may be different from the current resources allocated to the application before block 406 (e.g., partitions: 151; connections: 103; read: 82; write: 90).

In case that the resource management module 106a determines that one or more faults have been encountered (block 410, yes), the routine 400 moves to block 412. At block 412, the resource management module 106a transmits a notification indicating that one or more faults have been encountered. For example, the resource management module 106a may transmit a message indicating the one or more faults (e.g., describing in detail the one or more faults) directly to one or more users (e.g., via email). In another example, the resource management module 106a may transmit a message indicating the one or more faults (e.g., describing in detail the one or more faults) to a log (that is configured to record faults). In some embodiments, the resource management module 106a may additionally reduce the resource types in the in the first set of resource types back to their original values (e.g., connections: 259→103).

In the case that the resource management module 106a determines that no fault has been encountered (block 410, no), the routine 400 moves to block 414. At block 414, the resource management module 106a decreases the second set of resource types to be equivalent to the corresponding resources that were allocated during performance testing. For example, as discussed previously with respect to the example illustrated in FIG. 3A, the partitions resource type is included in the second set of resource types. Thus, the partitions resource type is decreased from 151 to 83. It should be noted that, while the example in FIG. 3A indicates that a single resource type is to be decreased, this may not necessarily always be the case. In other words, in case that the scaling values for the remaining resource types (other than the resource types in the first set of resource types), such as read and write, are associated with scaling value having a negative sign, such resource types may also be included in the second set of resources (and therefore be decreased).

As such, the application may still be allocated (at block 406) with the same current resources (e.g., connections: 259; read: 82; write: 90), with the exception of the resource types included in the second set of resource types (e.g., partitions: 151→83), which are, instead, increased to be the same value as in the resources allocated to application during performance testing. As such, the current resources allocated to the application at block 414 (e.g., partitions: 83; connections: 259; read: 82; write: 90) may be different from the current resources allocated to the application before block 406 (e.g., partitions: 151; connections: 103; read: 82; write: 90) and before block 414 (e.g., partitions: 259; connections: 103; read: 82; write: 90). At block 416, the application is entered into production. The routine ends at block 418.

### Example Routine for Executing Scale-up Procedure

When a routine described herein (i.e., 200, 300, 400, 500, 600, 700, 1000) is initiated, as set of executable program instructions stored on one or more non-transitory computer-readable media (e.g., hard drive, flash memory, removable media, etc.) may be loaded into memory (e.g., random access memory or RAM) of a computing device, such as the computing device 1200 shown in FIG. 12, and executed by one or more processors. In some embodiments, the routine 200, 300, 400, 500, 600, 700, 1000 or portions thereof may be implemented on multiple processors, serially or in parallel.

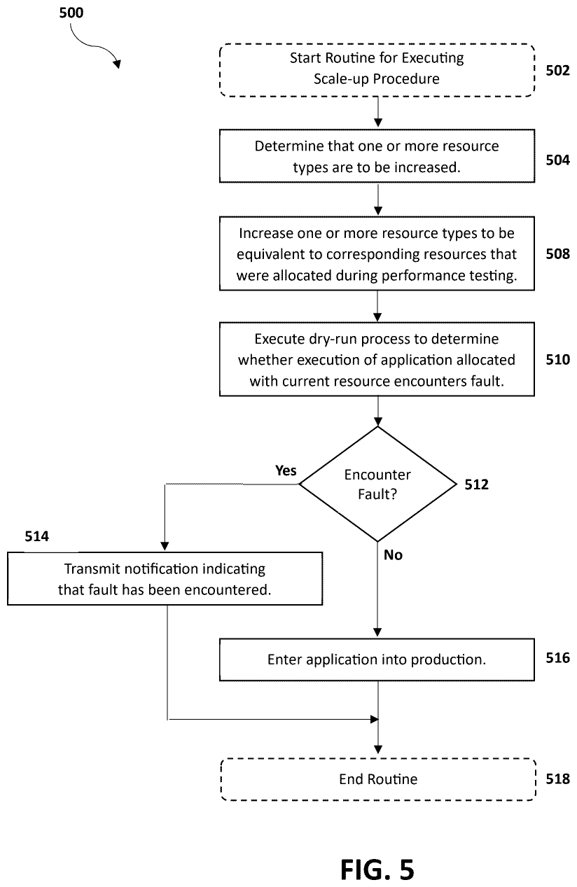

FIG. 5 illustrates example routine 500 (beginning at block 502) for executing a scale-up procedure, that is performed, for example, by at least the resource management module 106a. At block 504, the resource management module 106a determines that one or more resource types are to be increased. As discussed previously with respect to routine 200 in FIG. 2, the resource management module 106a may determine one or more scaling values based on the current resources allocated to the application and the resources allocated to the application during performance testing. The one or more scaling values indicate whether to increase, decrease, or maintain (e.g., keep the same) the current amount of resources (e.g., resource types) provided by the Kafka cluster (e.g., block 212 of routine 200 in FIG. 2) to the application. After determining the scaling values, the resource management module 106a determines the scaling procedure based on the one or more scaling values (e.g., block 218 of routine 200 in FIG. 2).

In case that one or more scaling values indicate that one or more resource types are to be increased (e.g., scaling value that is greater than zero) and the remaining resource types are to remain unchanged (e.g., scaling value of zero), the resource management module 106a determines that a scale-up procedure is to be performed (or executed). For example, with respect to the example illustrated in FIG. 3B, there are three resource types (e.g., partitions, read, write) associated with a scaling value that includes a positive sign (e.g., indicating an increase) and one resource type (e.g., connections) associated with a scaling value of zero (e.g., indicating no increase or decrease).

At block 508, the resource management module 106a increases the one or more resource types to be equivalent to corresponding resources that were allocated during performance testing. For example, as discussed previously with respect to the example illustrated in FIG. 3B, the one or more resource types to be increased includes the partitions resource type, the read resource type, and the write resource type. Thus, the partitions resource type is increased from 151 to 152, the read resource type is increased from 82 to 95, and the write resource type is increased from 90 to 123.

At block 510, the resource management module 106a executes a dry-run process to determine whether the execution of the application allocated with the current resource encounters one or more faults. As discussed previously, a dry-run may be a process (e.g., software testing process) to ensure that the system is operating correctly (e.g., does not result in severe failure). For example, a dry-run may allow a user (e.g., a person performing testing) to be informed on (or view) the operations that would be performed by the Kafka cluster without actually executing such operations. It should also be noted that, before the execution of the dry-run process, the application may still be allocated with the same current resources (e.g., connections: 0) with the exception of the one or more resource types that are to be increased (e.g., partitions: 151→152; read: 82→95; write: 90→123), which are, instead, increased to be the same value as in the resources allocated to application during performance testing. As such, the current resources allocated to the application at block 508 (e.g., partitions: 152; connections: 103; read: 95; write: 123) may be different from the current resources allocated to the application before block 508 (e.g., partitions: 151; connections: 103; read: 82; write: 90).

In case that the resource management module 106a determines that one or more faults have been encountered (block 512, yes), the routine 500 moves to block 512. At block 512, the resource management module 106a transmits a notification indicating that one or more faults have been encountered. For example, the resource management module 106a may transmit a message indicating the one or more faults (e.g., describing in detail the one or more faults) directly to one or more users (e.g., via email). In another example, the resource management module 106a may transmit a message indicating the one or more faults (e.g., describing in detail the one or more faults) to a log (that is configured to record faults). In some embodiments, the resource management module 106a may additionally reduce the any resource types that were increased (e.g., in block 508) back to their original values (e.g., partitions: 152→151; read: 95→82; write: 123→90). In the case that the resource management module 106a determines that no fault has been encountered (block 512, no), the routine 500 moves to block 516. At block 516, the application is entered into production with the current resources allocated at block 508 (e.g., partitions: 152; connections: 103; read: 95; write: 123). The routine ends at block 518.

### Example Routine for Executing Scale-down Procedure

When a routine described herein (i.e., 200, 300, 400, 500, 600, 700, 1000) is initiated, as set of executable program instructions stored on one or more non-transitory computer-readable media (e.g., hard drive, flash memory, removable media, etc.) may be loaded into memory (e.g., random access memory or RAM) of a computing device, such as the computing device 1200 shown in FIG. 12, and executed by one or more processors. In some embodiments, the routine 200, 300, 400, 500, 600, 700, 1000 or portions thereof may be implemented on multiple processors, serially or in parallel.

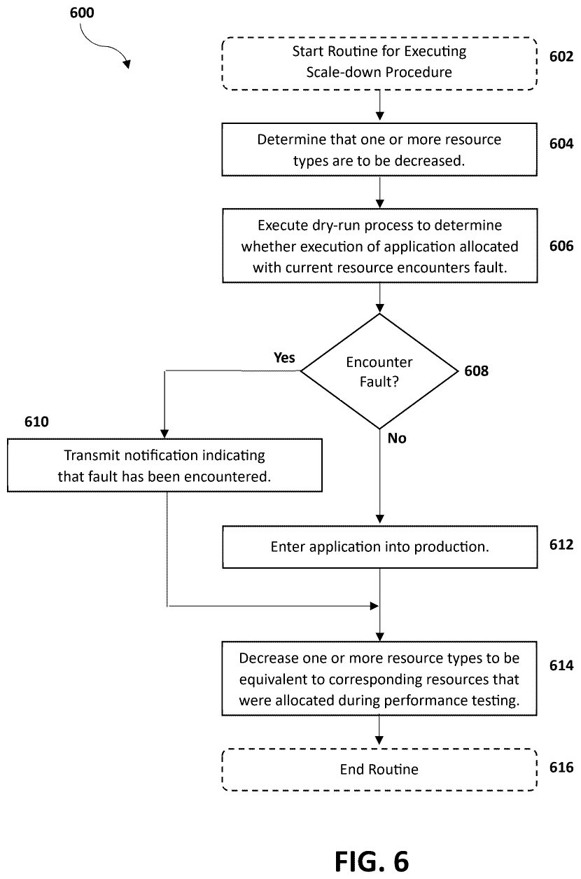

FIG. 6 illustrates example routine 600 (beginning at block 602) for executing a scale-up procedure, that is performed, for example, by at least the resource management module 106a. At block 604, the resource management module 106a determines that one or more resource types are to be decreased. As discussed previously with respect to routine 200 in FIG. 2, the resource management module 106a may determine one or more scaling values based on the current resources allocated to the application and the resources allocated to the application during performance testing. The one or more scaling values indicate whether to increase, decrease, or maintain (e.g., keep the same) the current amount of resources (e.g., resource types) provided by the Kafka cluster (e.g., block 212 of routine 200 in FIG. 2) to the application. After determining the scaling values, the resource management module 106a determines the scaling procedure based on the one or more scaling values (e.g., block 218 of routine 200 in FIG. 2).

In case that one or more scaling values indicate that one or more resource types are to be decreased (e.g., scaling value that is less than zero) and the remaining resource types are to remain unchanged (e.g., scaling value of zero), the resource management module 106a determines that a scale-down procedure is to be performed (or executed). For example, with respect to the example illustrated in FIG. 3C, there are three resource types (e.g., connections, read, write) associated with a scaling value that includes a negative sign (e.g., indicating a decrease) and one resource type (e.g., partitions) associated with a scaling value of zero (e.g., indicating no increase or decrease).

At block 606, the resource management module 106a executes a dry-run process to determine whether the execution of the application allocated with the current resources encounters one or more faults. As discussed previously, a dry-run may be a process (e.g., software testing process) to ensure that the system is operating correctly (e.g., does not result in severe failure). For example, a dry-run may allow a user (e.g., a person performing testing) to be informed on (or view) the operations that would be performed by the Kafka cluster without actually executing such operations. It should also be noted that, before the execution of the dry-run process, the application may still be allocated with the same current resources allocated before the start of routine 600 (e.g., partitions: 151; connections: 103; read: 82; write: 90).

In case that the resource management module 106a determines that one or more faults have been encountered (block 608, yes), the routine 600 moves to block 610. At block 610, the resource management module 106a transmits a notification indicating that one or more faults have been encountered. For example, the resource management module 106a may transmit a message indicating the one or more faults (e.g., describing in detail the one or more faults) directly to one or more users (e.g., via email). In another example, the resource management module 106a may transmit a message indicating the one or more faults (e.g., describing in detail the one or more faults) to a log (that is configured to record faults).

In the case that the resource management module 106a determines that no fault has been encountered (block 608, no), the routine 600 moves to block 612. At block 612, the application is entered into production with the current resources allocated before the start of routine 600 (e.g., partitions: 151; connections: 103; read: 82; write: 90). At block 614, the resource management module 106a decreases the one or more resource types to be equivalent to corresponding resources that were allocated during performance testing. For example, as discussed previously with respect to the example illustrated in FIG. 3C, the one or more resource types to be increased includes the connections resource type, the read resource type, and the write resource type. Thus, the connections resource type is decreased from 103 to 89, the read resource type is decreased from 82 to 64, and the write resource type is decreased from 90 to 33. In other words, the application is allocated with current resources at block 614 (e.g., partitions: 151; connections: 89; read: 64; write: 33) that are different from the current resources allocated before block 614 (e.g., partitions: 151; connections: 103; read: 82; write: 90). The routine ends at block 616.

Example Routine for Performing Configuration during Kafka Development Process

When a routine described herein (i.e., 200, 300, 400, 500, 600, 700, 1000) is initiated, as set of executable program instructions stored on one or more non-transitory computer-readable media (e.g., hard drive, flash memory, removable media, etc.) may be loaded into memory (e.g., random access memory or RAM) of a computing device, such as the computing device 1200 shown in FIG. 12, and executed by one or more processors. In some embodiments, the routine 200, 300, 400, 500, 600, 700, 1000 or portions thereof may be implemented on multiple processors, serially or in parallel.

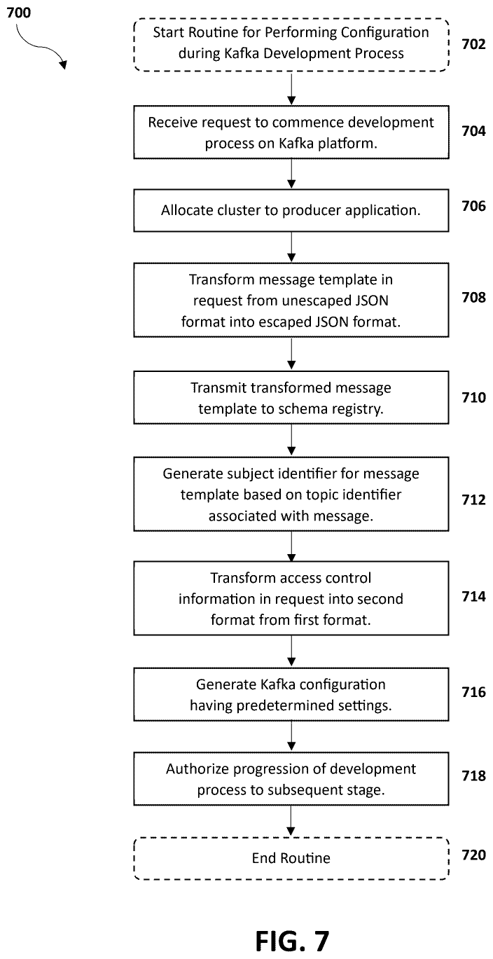

FIG. 7 illustrates example routine 700 (beginning at block 702) for performing configuration during development process of a Kafka platform to, for example, reduce errors during execution, that is performed, for example, by at least one of the development configuration module 106b and the Kafka user interface module 106c of the Kafka management server 106. At block 704, the development configuration module 106b receives a (development) request from a user to commence a development process on the Kafka platform (or system). In some embodiments, the development request may include the requested resources to allocate from one or more clusters, message templates, and access control information (which are all discussed infra). For example, the user may wish to establish (e.g., create or generate) a Kafka system (e.g., system 100) that involves having a producer application (e.g., Application A, Application B, or Application N) on a producer server (e.g., server 108a, server 108c, server 108d of producer servers 108) transmit one or more messages (e.g., record items corresponding to event data) to one or more brokers (e.g., broker 110a, broker 110b, broker 110c), which in turn, transmit the one or more messages to one or more consumer apps (e.g., App A, App B, App D, etc.) corresponding to one or more consumer devices (e.g., user device 112a, user device 112b, user device 112c of consumer devices 112).

Establishing such Kafka system may involve going through a development process. As discussed previously, the development process may include a production stage and one or more non-production stages. The production stage is when the (producer) application is deployed in a live environment for use by end-users (e.g., customers). The producer application may host real-world operations and may handle sensitive data. More specifically, during production, the application is operating in the “real-world” in which the application provides real (e.g., actual) data to the Kafka cluster (e.g., Kafka cluster 110), which transmits such data to each of the consumer devices (e.g., user devices 112a-112N).

Likewise, as discussed previously, the non-production stage is when the application is being developed, tested, and staged in one or more non-production environments. Such non-production environments may be isolated from the live environment and may use dummy or anonymized data to avoid compromising real-world operations. In some embodiments, the application may be simultaneously deployed in a live environment and a copy of the application may undergo development in a non-production environment (e.g., for updating the application). In other words, this may avoid interruption of services provided by the application.

The non-production stage may include one or more stages. Examples of non-production stages include, but are not limited to, the development stage and the testing stage. In the development stage, developers of the application may write, edit, and test code. For example, the development stage may be where the code for the producer application is first written. In another example, the producer application has already been created, tested, and entered into production. As such, in the case of an existing producer application, the development stage is where developers may update the existing producer application by writing new code, editing existing code, and testing the new or modified code in the producer application.

The testing stage may allow for validating software functionality, performance, and compatibility of a system or a producer application. The testing stage may include various types of testing such as, but not limited to, unit testing, system integration testing, performance testing, and user acceptance testing. The unit testing may include testing individual components or modules for accuracy. The system integrating testing may ensure that different components of the application work together as expected. The user acceptance testing may allow end-users or stakeholders to validate the performance of the application against one or more conditions (e.g., requirements). The user acceptance testing may allow end-users or stakeholders to validate the performance of the application against one or more conditions (e.g., requirements). The performance testing stage may involve evaluating the performance and/or scalability of a system or application. More details regarding performance testing are discussed below.

In some embodiments, the process of moving the producer application through the non-production stages is sequential, in which the sequence includes the following order: development stage then testing stage. In some embodiments the process of moving the producer application through each stage in the testing stage is sequential, in which the sequence includes the following order: unit testing stage, system integration testing stage, user acceptance testing stage, and performance testing stage. It should be noted that the stages in the testing stage can be performed in any order and is not limited to the aforementioned sequence.

At block 706, the development configuration module 106a allocates one or more clusters to a producer application. As discussed previously, a producer application may transmit one or more messages to one or more brokers in a Kafka cluster. The one or more messages are, in turn, transmitted to one or more consumer apps. As is evident, the transmission of the one or more messages (whether from the producer application or the consumer app) utilizes one or more resources (e.g., partitions, connections, reads, writes, etc.). As such, the user may specify (in development request) the resources to be utilized by the producer application during the development process.

In some embodiments, the development configuration module 106a may automatically arrange for specific partition configurations to be set when the allocating one or more clusters to the producer application. As discussed previously, the event data generated by a producer application may be divided (or grouped) according to a topic. Further, the topics may each be divided into one or more partitions. In turn, each partition of the one or more partitions may include one or more record items that are each included in the proper partition (e.g., by a broker) based on the event key included in the record item. The one or more record items are stored in the proper partition (e.g., via appending) such that the one or more record items are in a consecutive order (e.g., based on the time in which the record items arrive at the proper partition) with each record item being identified in the proper partition based on an offset value.

Consequently, the specific partition configuration may include allocating a leading partition and one or more contingency (e.g., replica) partitions for each partition. The contingency partitions provide backup in case the leading partition fails. For example, when the producer application transmits a record item to a broker, the record item is disposed (by the broker) to a specific partition according to the event key in the record item. More specifically, the record item is first received by a leading (e.g., main) partition. The leading partition stores the record item, and then may generate a duplicate (e.g., a copy) of the record item for each associated contingency partition (e.g., may be disposed of in different brokers from the leading partition). The leading partition may transmit such duplicates to the proper contingency partition.

At block 708, the development configuration module 106a transforms the message template (or schema) in the (development) request from an unescaped JSON (JavaScript Object Notation) format into an escaped JSON format. The message template (or schema) may indicate the format (e.g., including datatype of each field item in the message template) of each record item corresponding to event data transmitted by the producer application. For example, in the case of that the event data corresponded to scores in a sports game, the message template may include at least one of the home team (string datatype), the visiting team (string datatype), the score of the home team (integer datatype), the score of the visiting team (integer datatype), and the timestamp (integer datatype). In some embodiments, the development request may also include a key schema that indicates the format of a key value in a record item (e.g., the key value determining the partition in a broker to which the record item is to be transmitted).

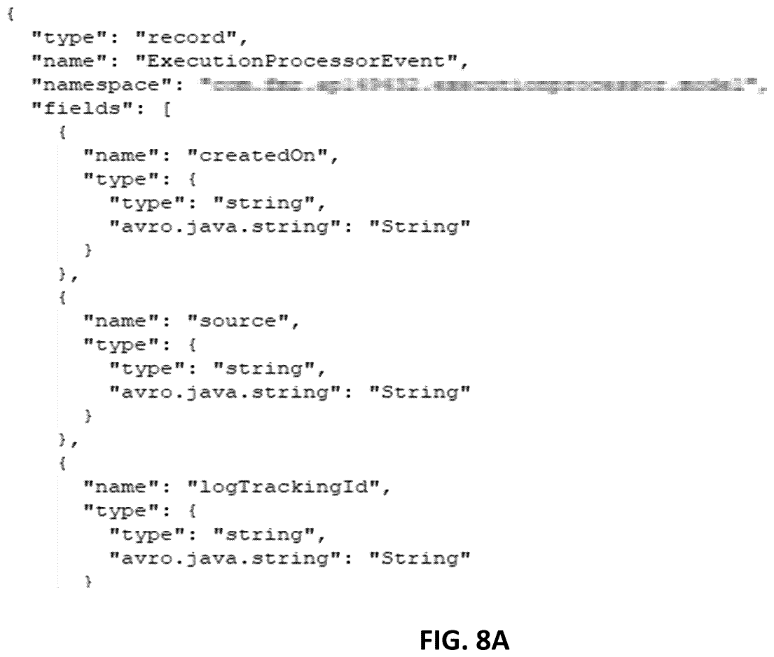

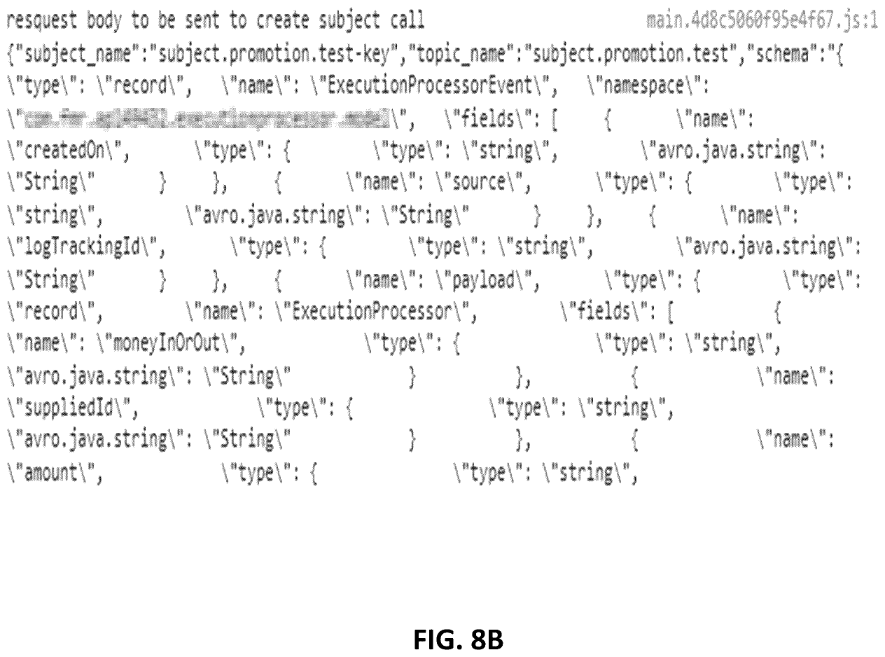

One reason for allowing the user to submit the message template (in the development request) in the JSON format is that the user is less likely to generate errors when generating a message template in the unescaped JSON format. Indeed, as shown in FIG. 8A, the unescaped JSON format is much more (human) readable in view of the escaped JSON format shown in FIG. 8B. It should be noted that the message template in both FIGS. 8A and 8B are the same, but one is the unescaped JSON format (FIG. 8A) and the other is in the escaped JSON format (FIG. 8B). In the conventional case of having the user generate message templates using the escaped JSON format, errors may be easily introduced into the message template. Such errors are extremely difficult to identify, especially in cases in which the message template is large (e.g., includes numerous field items). It should also be noted that one reason for transforming the message template from the unescaped JSON format into the escaped JSON format may be due to the fact that at least one of the producer application, the one or more brokers, and the one or more consumer apps may process the messages according to the escaped JSON format (rather than the unescaped JSON format).

At block 710, the development configuration module 106a transmits the transformed message template to schema registry. As discussed previously, the message template may originally be submitted by the user in the unescaped JSON format. As such, the transformed message template may be the message template (originally in the unescaped JSON format) transformed into the escaped JSON format. The schema registry may be a component (e.g., database) that manages and stores schemas for data exchanged between the producer application and one or more consumer apps. The schema registry may ensure that data is consistent and compatible, and that messages sent by the producer application correspond to the format expected by the consumer apps. For example, the producer application may serialize (e.g., convert data object into a data representation, such as a series of bytes, that facilitates transportation of the data object) a record item (according to the corresponding message template or schema). When the consumer app receives the serialized record item, the consumer app my access the schema registry to determine the message template (e.g., schema) corresponding to the record item, and deserialize e.g., convert, for example, the series of bytes, back into the original data object) the record item based on the message template.

At block 712, the development configuration module 106a (automatically) generates a subject identifier for the (transformed) message template based on a topic identifier associated with a message. For example, the development configuration module 106a may generate the subject identifier by appending the corresponding topic identifier with “-key” or “-value” (e.g., topic identifier: hockey; subject identifier: hockey-key). More specifically, each message (e.g., record item) may correspond to a topic (e.g., topic identifier). Further, the format of each message may be based on a message template (e.g., schema) that is identified using a subject identifier. In addition, as discussed above, when the consumer app receives the serialized record item, the consumer app my access the schema registry to determine the message template (e.g., schema) corresponding to the record item, and deserialize e.g., convert, for example, the series of bytes, back into the original data object) the record item based on the message template. More specifically, the consumer app may determine the message template using the subject identifier. Since the consumer app is able to deserialize the message template using the subject identifier, it is important that consumer app be able to search and discover the subject identifier. Such search may be facilitated by using the topic identifier to generate the corresponding subject identifier, and then determining which message template (e.g., schema) matches the subject identifier.

Further, in some embodiments, the subject identifier may be unmodifiable by the user (e.g., the user is not permitted to modify the subject identifier). One reason for ensuring that the subject identifier is generated based on the topic identifier is that it is possible to generate incompatible or non-standard subject identifiers for respective topic identifiers. The incompatible or non-standard subject identifiers can lead to misconfigurations, the occurrence of mismatch related errors, and frequent deletion of topics in clean-up processes since the topic identifiers do not match the subject identifiers. Further problems may include difficulty in troubleshooting as well as the time consumed in troubleshooting.

At block 714, the development configuration module 106a transforms the access control information in the development request from a first format into a second format. For example, the access control information in the development request indicates which users or applications (e.g., producers, consumers, etc.) can perform specific actions on Kafka resources (e.g., partitions, connections, reads, writes, etc.), topics, groups of consumer apps, or brokers. In a further example, the access control information may specify users who are permitted to authorize the progression of the development process. For example, users authorized in the access control information can authorize (e.g., by transmitting a progression request) a Kafka system to progress from one stage (e.g., development stage) to a subsequent stage (e.g., unit testing stage). Consequently, users not authorized in the access control information may not be able to authorize a Kafka system to progress from one stage to a subsequent stage.

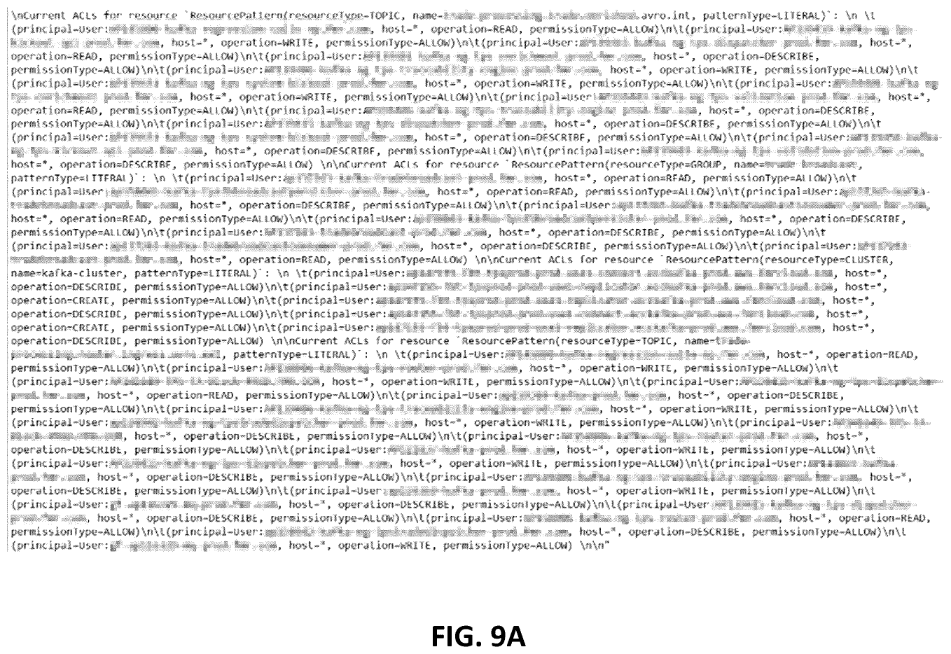

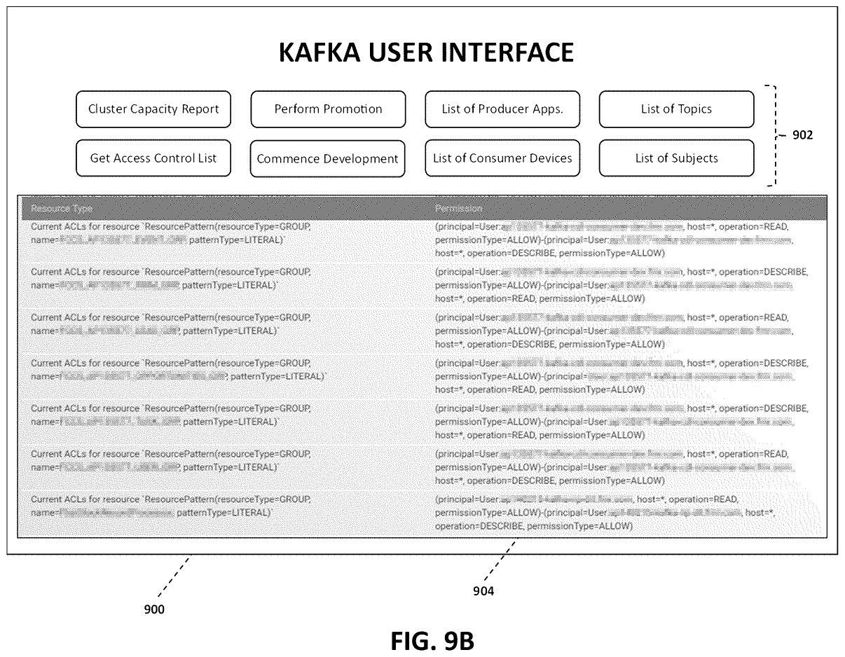

For example, the second format may be shown by FIG. 9A. The first format may be a human-readable format (e.g., JSON) that can easily be generated by the user (with little to no mistakes). In some embodiments, the development configuration module 106a stores the access control information in an access control database (e.g., the access control information may be stored in the access control database in the second format). For example, the development configuration module 106a may store the access control information in the access control database as an access control list.

One reason for allowing the user to generate the access control information is that errors frequently occur when entities (e.g., producers, consumers, subjects) lack proper access controls, thereby causing one or more components of the Kafka system (e.g., system 100) to fail or performs an unintended action (due to improper permissions). As can be seen by FIG. 9A, it is very difficult for a human to identify the specific error in the access control information due to the complexity of the second format.

At block 716, the development configuration module 106a generates a Kafka configuration that includes predetermined settings. The Kafka configuration may, for example, include a configuration file that includes at least one of parameters, options, settings and preferences that are applied to the Kafka system. For example, the Kafka configuration may include instructions that the Kafka system is to follow during execution (e.g., execution performed during the testing and production stages). It should be noted that the predetermined settings may be automatically generated after allocating one or more clusters in response to the development request transmitted by the user. Further, it should be noted that one or more of the predetermined settings may be unmodifiable by the user. Likewise, it should also be noted that one or more of the predetermined settings may be modifiable by the user.

In some embodiments, the predetermine settings include a first setting that causes the cluster in the Kafka platform to register a successful write of a message when the Kafka platform receives acknowledgement from the leading partition and at least one contingency (e.g., replica) partition. More specifically, when a producer application transmits a message (e.g., record item) to a partition of a broker, the cluster may determine whether the message was successfully written to the partition. For example, success can mean that the message was written entirely (e.g., without any data loss) in the partition and that the data in the message is uncorrupted and does not contain any errors. In some examples, the broker may transmit a retransmission request to the producer application to cause the producer application to retransmit the message in case of an unsuccessful write of the message in the partition.

Consequently, as discussed above, when a producer application transmits a message (e.g., record item) to a partition of a broker, the leading partition generates one or more duplicate messages. The leading partition then transmits the duplicate messages to each contingency partition. The duplicate messages are then written (e.g., stored) into the corresponding contingency partitions. When there is a successful storage of a particular duplicate message, the corresponding contingency partition transmits an acknowledgement to the leading partition. As such, when it is determined that the leading partition has successfully stored the message and the leading partition receives an acknowledgement from at least one contingency partition (e.g., receives acknowledgement from at least two contingency partitions), the cluster in the Kafka platform to register a successful write of a message. In some embodiments, the first setting is unmodifiable.

In some embodiments, the predetermine settings include a second setting that causes a message to be removed from corresponding leading and contingency partitions after an expiration of a predetermined time period. The predetermined time period may commence after the message has already been consumed by each consumer app. As discussed previously, a message (and its duplicates) may be stored in the leading partitions and one or more corresponding contingency partitions. However, one or more of the messages may have already been consumed (e.g., received) by each of the consumer apps. As such, there is no reason to maintain the messages in the (leading and contingency) partitions. Otherwise, maintaining already consumed messages can cause capacity related issues, which lead to outages in the Kafka system. Consequently, as discussed above, the second setting ensures that one or more messages are removed from corresponding leading and contingency partitions after an expiration of a predetermined time period. In some embodiments, the second setting is unmodifiable.

In some embodiments, the predetermine settings include a third setting that manages the access control information. As discussed previously, the access control information is stored by the Kafka configuration (e.g., in an access control database) according to a second format and is transformed to a first format (e.g., which is human-readable) when the access control information is requested by the user. More specifically, the user is allowed to view or modify the access control information at any stage in the development process (e.g., non-production and production stages). As such, when the user submits a request for the access control information, the development configuration module 106a may retrieve the access control information from, for example, the access control database. The access control information may be stored in the second format (e.g., as shown in FIG. 9A). Consequently, the development configuration module 106a may transform the access control information from a second format into a first format. While it has been stated that the second format includes JSON, any other human-readable format may be used.

An example of the access control information returned to the user according to another first format (e.g., non-JSON format) is shown in FIG. 9A, which also illustrates a Kafka user interface 900 (which is discussed in more detail infra). For example, the user may select the “Get Access Control List” button 902 on the Kafka user interface to cause development configuration module 106a to return an information interface 904 that displays the access control information in a human-readable format. As shown, the information interface 904 in FIG. 9B displays the access control information in a first format that shows one or more resource types and the corresponding permissions.

The user may modify the access control information displayed in the information interface 904 of FIG. 9B. After the user has modified the access control information to generate modified access control information (which is still in the first format), the development configuration module 106a transforms the modified access control information from first format into the second format. Further, the development configuration module 106a may store the modified access control information (which is in the second format) into the access control database.

At block 718, the development configuration module 106a authorizes progression of the development process to a subsequent stage. As discussed previously, certain authorized users as indicated in the access control information are allowed to authorize progression of a development process from a current stage to a subsequent stage (e.g., the stages include at least one of code development, unit testing, system integration testing, performance testing, and user acceptance testing, and production). Consequently, the development configuration module 106a determines whether the user is an authorized user. If the user is an authorized user, the development configuration module 106a authorizes the progression of the development process from the current stage to the subsequent stage. Otherwise, in the case that the user is not authorized, the development configuration module 106a does not authorizes the progression of the development process from the current stage to the subsequent stage (i.e., the development process remains at the current stage).

It should be noted that the user may access the Kafka system using the Kafka user interface 900, as shown in FIG. 9B, in which the Kafka user interface 900 is provided by the Kafka user interface module 106c. It should be noted that, conventionally, users (e.g., IT administrators) interact with the Kafka platform via a command-line interface. Having a non-visual interface may be problematic because it is difficult to visualize the Kafka system (as a whole or in components). In other words, currently there is no user interface for communicating with (or providing commands to) the Kafka system (e.g., including clusters, brokers, etc.). The Kafka user interface 900 may be accessible via an app on the client computing device 102 or may be displayed as one or more web pages that are each accessible by the user using a web browsing application on the client computing device 102. As shown, the Kafka user interface includes one or more buttons 902 (e.g., “Cluster Capacity Report”, “Perform Promotion”, “List of Producer Applications”, “List of Topics”, “Get Access Control List”, “Commence Development”, “List of Consumer Devices”, and “List of Subjects”).

The Kafka user interface 900 may display a different information interface 904 depending on the buttons 902 activated by the user. For example, by activating the “List of Producer Applications” button 902, the information interface 904 may display the list of producer applications that are currently in the Kafka system. In another example, by activating the “List of Consumer Devices” button 902, the information interface 904 may display the list of consumer devices (e.g., consumer apps) that are currently in the Kafka system. In yet another example, by activating the “List of Topics” button 902, the information interface 904 may display the list of topics that are currently in the Kafka system. In a further another example, by activating the “List of Subject” button 902, the information interface 904 may display the list of subject identifiers (e.g., corresponding to message templates or schemas) that are currently in the Kafka system.

Further, when the user activates the “Commence Development” button 902, the Kafka user interface module 106c may, via the information interface 904, request the user for information with respect to a development request. After receiving the development request, the routine 700 may commence (e.g., after the user has transmitted the development request). In some embodiments, the routine may automatically execute the actions in at least one of blocks 702, 704, 706, 708, 710, 712, 714, and 716. In addition, when the user activates the “Get Access Control List” button 902, the access control information is returned to the user according to a first format as shown in FIG. 9A. As discussed previously, the user may modify the access control information displayed in the information interface 904 of FIG. 9B. Moreover, when an authorized user activates the “Perform Promotion” button, the development process moves from the current stage to the subsequent stage (e.g., block 718 of FIG. 7). As discussed previously, the stages in the development process may include at least one of code development, unit testing, system integration testing, performance testing, user acceptance testing, and production. The “Cluster Capacity Report” button 902 is explained in more detail infra.

### Example Routine for Detecting Failures in Kafka Clusters

When a routine described herein (i.e., 200, 300, 400, 500, 600, 700, 1000) is initiated, as set of executable program instructions stored on one or more non-transitory computer-readable media (e.g., hard drive, flash memory, removable media, etc.) may be loaded into memory (e.g., random access memory or RAM) of a computing device, such as the computing device 1200 shown in FIG. 12, and executed by one or more processors. In some embodiments, the routine 200, 300, 400, 500, 600, 700, 1000 or portions thereof may be implemented on multiple processors, serially or in parallel.

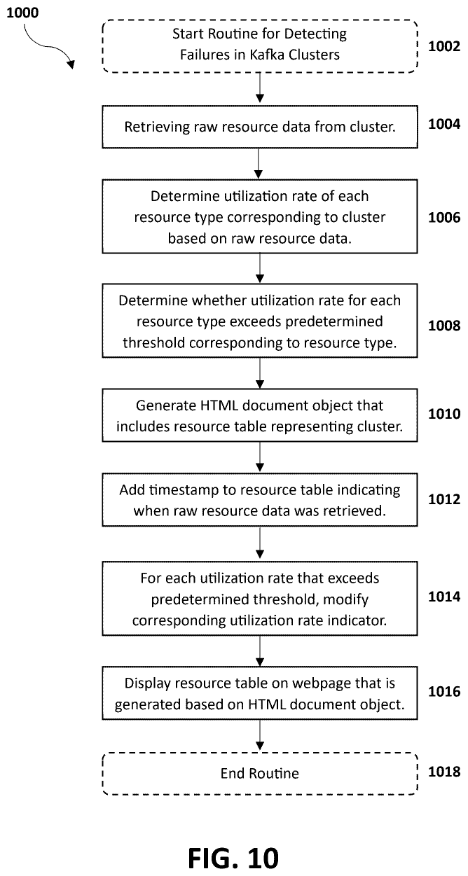

FIG. 10 illustrates example routine 1000 (beginning at block 1002) for detecting failures in Kafka clusters, that is performed, for example, by at least one of the cluster analysis module 106d of the Kafka management server 106. At block 1004, the cluster analysis module 106d may retrieve raw resource data from a Kafka cluster (e.g., Kafka cluster 110). For example, the raw resource data may include data (e.g., raw partitions data, raw connections data, raw read data, raw write data, etc.) regarding different resource types (e.g., partitions, connections, read, write, etc.) that correspond to resources provided by the Kafka cluster.

More specifically, the raw partitions data may include the number of free (e.g., unused) partitions and the total number of partitions, the raw partitions data may include the number of free (e.g., unused) partitions and the total number of partitions (e.g., that can be used), the raw connections data may include the number of free (e.g., unused) connections and the total number of connections (e.g., connections that can be used), the raw read data may include the number of free (e.g., unused) reads and the total number of reads (e.g., reads that can be performed), and the raw write data may include the number of free (e.g., unused) writes and the total number of writes (e.g., writes that can be performed).

At block 1006, the cluster analysis module 106d determines the utilization rate of each resource corresponding to the cluster based on the raw resource data. More specifically, the utilization rate may be a percentage of the number of used resources to the total number of resources corresponding to a resource type. The number of used resources may be determined by subtracting the number of free resources from the total number of resources for a specific resource type.

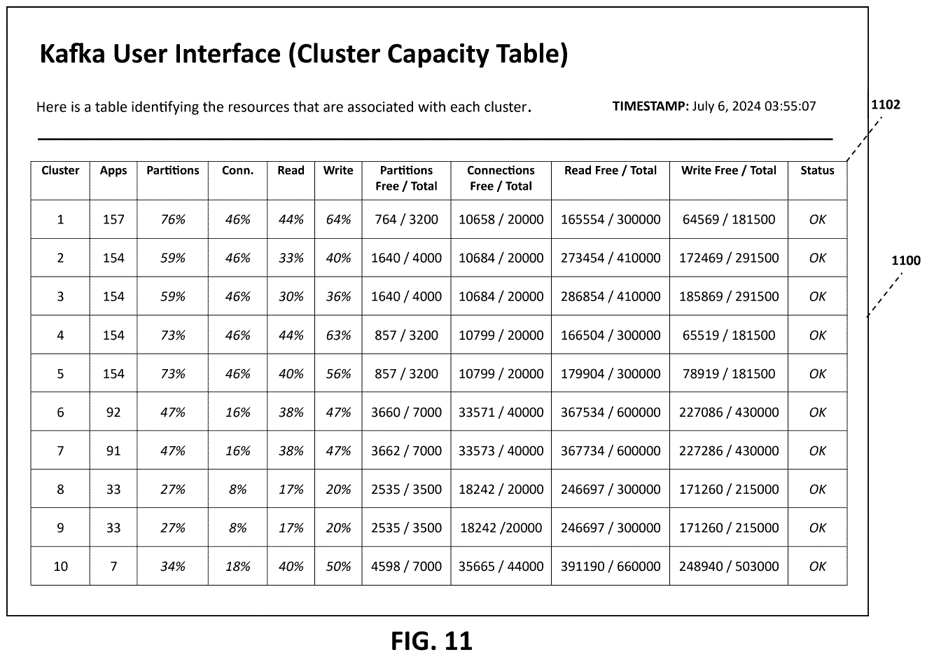

For example, as shown in FIG. 11 with respect to Cluster 1, the number of free partitions is 764, the total number of partitions is 3200, the number of free connections 10658, the total number of connections is 20000, the number of free reads is 165554, the total number of reads is 300000, the number of free writes is 64569, and the total number of writes is 181500. Using the aforementioned numbers, the cluster analysis module 106d determines the number of used partitions to be 2436 (i.e., 3200−764=2436), the number of used connections to be 9342 (i.e., 20000-10658), the number of used reads to be 134446 (i.e., 300000−165554=134446), and the number of used writes to be (i.e., 181500-64569=116931). As such, the cluster analysis module 106d determines the partitions utilization rate to be 76%, the connections utilization rate to be 46%, the read utilization rate to be 44%, and the write utilization rate to be 64%.

At block 1006, the cluster analysis module 106d determines whether the utilization rate for each resource type exceeds one or more predetermined thresholds corresponding to the resource type. In other words, errors may occur when, for example, one or more applications are attempting to use resources that exceed the maximum amount of resources that are capable of being provided by the Kafka cluster (e.g., utilization rate goes beyond 100%). In some embodiments, the errors may occur even when the utilization rate does not reach 100%. More specifically, for example, as the utilization rate reaches to be close to 100% (e.g., between 93% to 99%), the Kafka cluster may struggle to perform operations

Consequently, the one or more predetermined thresholds may be arranged in a predetermined order (e.g., sequenced) based on an urgency or severity of the error that may occur in the Kafka cluster. In other words, a higher urgency level (e.g., based on priority) indicates a more serious or a more pressing error has occurred (or may occur) in the Kafka cluster. Conversely, a lower urgency level (e.g., based on priority) indicates a less serious error has occurred (or may occur) in the Kafka cluster. In some embodiments, a larger valued urgency (e.g., a larger number) signifies a more urgent error detected in the Kafka cluster, while a lower valued urgency level (e.g., a smaller number) signifies a minor error detected in the Kafka cluster.

In further embodiments, when a utilization rate of a resource associated with the cluster reaches a first predetermined threshold, the status indicator indicates a warning status, which is an alarm status that is color-coded according to a first color (e.g., yellow). In some embodiments, when a utilization rate of a resource associated with the cluster reaches a second predetermined threshold, the status indicator indicates an alert status, which is an alarm status that is color-coded according to a second color (e.g., red). In some embodiments, the first color and the second color are different from each other.

At block 1010, the cluster analysis module 106d generates an HTML (Hypertext Markup Language) document object that includes a resource table representing one or more Kafka clusters. The HTML document object may correspond to an object under the Document Object Model (DOM). More specifically, the DOM may, for example, connect web pages to scripts (e.g., JavaScript) or programming languages (e.g., markup language, stylesheet language, etc.) by representing the structure of a document in memory. Consequently, when a web browser receives a document object, the web browser may render the document object based on the scripts or programming languages (e.g., HTML, Cascading Style Sheets (CSS), etc.) that are associated with the document object. In other words, the

More specifically, HTML document object may include a structure of nested HTML elements. These are indicated in the document by HTML tags, enclosed in angle brackets that include a start tag (e.g., <p>) and an end tag (e.g., </p>). There may be more than one type of HTML tag that causes the web browser to render the content designated between the start tag and the end tag in a different manner. For example, the start tag <table> and end tag </table> may indicate that a table is to be rendered by the web browser. In another example, the start tag <strong> and end tag </strong> may indicate that the content included between the aforementioned tags is to be rendered by the web browser to include a bold font. As discussed further infra, the resource table (e.g., formatted as an HTML document object) may be included in a web page (that may also be generated by the cluster analysis module 106d). An example of such web page 1100 is shown in FIG. 1, in which the web page 1100 may include the resource table 1102.

At block 712, the cluster analysis module 106d adds a timestamp to the resource table indicating when raw resource data was retrieved. The timestamp may include one or more time units of seconds, hour, day, month, year, etc. In some embodiments, the timestamp may be included as metadata in the resource table. In other embodiments, the HTML document object may be modified to include the timestamp (e.g., HTML code corresponding to the timestamp is added into the HTML document object). In further embodiments, the timestamp may be displayed on the same web page 1100 as the resource table 1102 as shown, for example, in FIG. 11 (e.g., “TIMESTAMP: Jul. 6, 2024 03:55:07”). The timestamp may notifier the user regarding the time in which the raw resource was retrieved. In other words, the timestamp may indicate whether the information presented by the resource table 1102 is outdated.

At block 1014, the cluster analysis module 106d modifies the corresponding utilization rate indicator for each utilization rate that exceeds a predetermined threshold. As discussed previously, the cluster analysis module 106d determines whether the utilization rate for each resource type exceeds one or more predetermined thresholds corresponding to the resource type. In other words, errors may occur when, for example, one or more applications are attempting to use resources that exceed the maximum amount of resources that are capable of being provided by the Kafka cluster (e.g., utilization rate goes beyond 100%). Consequently, the one or more predetermined thresholds may be arranged in a predetermined order (e.g., sequenced) based on an urgency or severity of the error that may occur in the Kafka cluster.

For example, when a utilization rate of a resource associated with the cluster reaches a first predetermined threshold, the status indicator indicates a warning status, which is an alarm status that is color-coded according to a first color (e.g., yellow). In some embodiments, when a utilization rate of a resource associated with the cluster reaches a second predetermined threshold, the status indicator indicates an alert status, which is an alarm status that is color-coded according to a second color (e.g., red).

In some embodiments, the status indicator may correspond to the “status” heading in the resource table 1102 of the web page 1100 that is illustrated in FIG. 11. More specifically, the status indicator may indicate one or more statuses such as, for example, “OK” (e.g., utilization rate does not reach any predetermined threshold), “WARNING” (e.g., utilization rate reaches a first predetermined threshold), “ALERT” (e.g., utilization rate reaches a second predetermined threshold), etc. In addition, as discussed previously, the one or more statuses may include a specifically colored font. For example, “OK” may correspond to green, “WARNING” may correspond to yellow, and “ALERT” may correspond to red.

As discussed previously, the cluster analysis module 106d may have generated a resource table (e.g., 1102 in FIG. 11) in an HTML format. As such, the cluster analysis module 106d may modify the HTML code corresponding to the HTML table. For example, in cases in which the status indicator corresponds to a specific color, the cluster analysis module 106d may modify the code corresponding to the status indicator to include HTML tags that cause the font to be in a certain color (e.g., <font color-“green”>OK</font>, <font color=“yellow”>WARNING </font>, (e.g., <font color=“red”>ALERT </font>). In some embodiments, the cluster analysis module 106d may further modify the code corresponding to the status indicator to include HTML tags that cause the font to highlight, for example, the severity of the issue or error (e.g., <font color=“yellow”><i>WARNING </i></font>, (e.g., <font color=“red”><strong>ALERT </strong></font>).

At block 1016, the Kafka user interface module 106c displays the resource table on a resource webpage that is generated based on the HTML document object. More specifically, the resource web page may be generated using one or more scripting languages (e.g., JavaScript) or programming languages (e.g., HTML, CSS). In some embodiments, the cluster analysis module 106d may use a web page template in generating the web page. The web page template may include predetermined code (e.g., JavaScript, HTML, CSS) that is static (e.g., not modified by the cluster analysis module 106d). The cluster analysis module 106d may modify the web page template to include code from the HTML document object (e.g., merge the HTML document object with the web page template) so as to generate the resource web page.

Next, the Kafka user interface module 106c may cause the resource webpage (e.g., web page 1100 of FIG. 11) to be transmitted to, for example, the client computing device 102. For example, the client computing device 102 may include one or more software applications, such as a web browser (that is utilized to render web pages before the user). After receiving the resource web page, the web browser on the client computing device 102 may display the resource web page before the user. For example, the user may be shown resource web page 1100 of FIG. 11, in which the user is shown the resources (e.g., resource types), their respective utilization rates, and the corresponding status indicator. The routine ends at block 1018.

In some embodiments, the “Cluster Capacity Table” may be displayed in the information interface 904 of FIG. 9. More specifically, when a user activates the “Cluster Capacity Report” button 902, the cluster analysis module 106d performs actions corresponding to each block in routine 1000 (e.g., blocks 1002, 1004, 1006, 1008, 1010, 1012, 1014, 1016, and 1018). Afterwards, Kafka user interface module 106c displays the “Cluster Capacity Table” on the information interface 904 of the Kafka user interface 900.

In some embodiments, the cluster analysis module 106d may continuously receive updated raw resource data (e.g., from the one or more clusters). For example, the cluster analysis module 106d may retrieve (or receive) such updated raw resource data at predetermined time intervals (e.g., once every second, minute, or hour, etc.). After receiving or retrieving the updated raw resource data, the cluster analysis module 106d performs the actions corresponding to blocks 1006, 1008, 1010, 1012, 1014, 1016, and 1018 (e.g., using the cluster analysis module 106d). Consequently, the cluster analysis module 106d generates a new resource table is generated based on the updated raw resource data (e.g., at block 1010) and displays the new resource table on a new web page or the information interface 904 of the Kafka user interface 900 (e.g., at block 1016).

### Execution Environment

FIG. 12 illustrates various components of an example computing device 1200 configured to implement various functionality described herein.

In some embodiments, the computing device 1200 may be implemented using any of a variety of computing devices, such as server computing devices, desktop computing devices, personal computing devices, mobile computing devices, mainframe computing devices, midrange computing devices, host computing devise, or some combination thereof.

In some embodiments, the features and services provide by the computing device 1200 may be implemented as webs services consumable via one or more communication networks. In further embodiments, the computing device 1200 is provided by one or more virtual machines implemented in a hosted computing environment. The hosted computing environment may include one or more rapidly provisioned and released computing resources such as computing devices, networking devices, and/or storage devices. A hosted computing environment may also be referred to as a “cloud” computing environment.

In some embodiments, as shown, a computing device 1200 may include one or more processors 1202, such as physical central processing units (“CPUs”); one or more network interfaces 1204, such as network interface cards (“NICs”); one or more computer readable medium drives 1206, such as a high density disk (“HDDs”), solid state drives (“SSDs”), flash drives, and/or other persistent computer readable media; one or more input/output drive interfaces 1208; and one or more computer-readable memories 1210, such as random access memory (“RAM”) and/or other volatile non-transitory readable media.

The one or more computer-readable memories 1210 may include computer program instructions that one or more computer processors 1202 execute and/or data that the one or more computer processors 1202 use in order to implement one or more embodiment. For example, the one or more computer-readable memories 1210 can store an operating system 1212 to provide general administration of the computing device 1200. As another example, the one or more computer-readable memories 1210 can store a general authorization module 1214 (e.g., resource management module 106a) for managing resources in Kafka cluster (or system) during a development process (e.g., non-production and production). In a further example, the one or more computer-readable memories 1210 can store a development configuration module 1216 (e.g., development configuration module 106b) for generating a development process and for configuring a Kafka system during such development process. In yet another example, the one or more computer-readable memories 1210 can store a Kaka user interface module 1218 (e.g., Kafka user interface module 106c), which generates a user interface to be displayed before the user (e.g., displaying information regarding the development process, configurations, or the Kafka cluster or system). In a further example, the one or more computer-readable memories 1210 can store a cluster analysis module 1220 (e.g., Kafka cluster analysis module 106d), which generates a cluster capacity report indicating information regarding the currently allocated resources of the Kafka cluster.

### Terminology

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus (e.g., a programmable processor, a computer, and/or multiple computers). A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry (e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like). Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data (e.g., magnetic, magneto-optical disks, or optical disks). A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices (e.g., DRAM, SRAM, EPROM, EEPROM, and flash memory devices); magnetic disks (e.g., internal hard disks or removable disks); magneto-optical disks; and optical disks (e.g., CD, DVD, HD-DVD, and Blu-ray disks). The processor and the memory can be supplemented by and/or incorporated in special purpose logic circuitry.

To provide for interaction with a user, the above-described techniques can be implemented on a computing device in communication with a display device (e.g., a CRT (cathode ray tube), plasma, or LCD (liquid crystal display) monitor, a mobile device display or screen, a holographic device and/or projector, for displaying information to the user and a keyboard and a pointing device (e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback (e.g., visual feedback, auditory feedback, or tactile feedback; and input from the user can be received in any form, including acoustic, speech, and/or tactile input).

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco Unified IP Phone 7985G and/or a Cisco® Unified Wireless Phone 7920 available from Cisco Systems, Inc.

The above-described techniques can be implemented using supervised learning and/or machine learning algorithms. Supervised learning is the machine learning task of learning a function that maps an input to an output based on example input-output pairs. It infers a function from labeled training data consisting of a set of training examples. Each example is a pair consisting of an input object and a desired output value. A supervised learning algorithm or machine learning algorithm analyzes the training data and produces an inferred function, which can be used for mapping new examples.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A computerized method for automatically managing resources allocated to an application utilizing a Kafka platform, the method comprising:
determining, by a server computing device, whether to modify a first amount of resources currently allocated to an application that is to enter production after being subjected to performance testing, the determination being performed by:
determining a second amount of resources that were utilized by the application during a previous production;
determining a third amount of resources that were utilized by the application during performance testing; and
generating a scaling value based on the second amount of resources and the third amount of resources, wherein the scaling value determines a scaling procedure for modifying the first amount of resources,
wherein, in case that the scaling value indicates that the first amount of resources is to be increased and then decreased, performing by the server computing device, a first scaling procedure by:
increasing the first amount of resources to be equivalent to the third amount of resources;
performing a dry-run test to determine whether the execution of the application allocated with the first amount of resources encounters at least one fault;
causing the application to enter production after determining that no faults were encountered during the dry-run test; and
decreasing the first amount of resources to be equivalent to the second amount of resources.

2. The computerized method of claim 1, wherein, in case that the scaling value indicates that the first amount of resources is to be increased, performing by the server computing device, a second scaling procedure by:
increasing the first amount of resources to be equivalent to the second amount of resources;
performing a dry-run test to determine whether the execution of the application allocated with the first amount of resources encounters at least one fault; and
causing the application to enter production after determining that no faults were encountered during the dry-run test.

3. The computerized method of claim 1, wherein, in case that the scaling value indicates that the first amount of resources is to be decreased, performing by the server computing device, a third scaling procedure by:
performing a dry-run test to determine whether the execution of the application allocated with the first amount of resources encounters at least one fault;
causing the application to enter production after determining that no faults were encountered during the dry-run test; and
decreasing the first amount of resources to be equivalent to the second amount of resources.

4. The computing system of claim 1, wherein, in case that the scaling value indicates that the first amount of resources is to remain unmodified, performing by the server computing device, a non-scaling procedure by:
performing a dry-run test to determine whether the execution of the application allocated with the first amount of resources encounters at least one fault; and
causing the application to enter production after determining that no faults were encountered during the dry-run test.

5. The computing system of claim 1, wherein the Kafka platform comprises a cluster that includes one or more brokers, wherein each broker includes one or more partitions, and wherein at least one of the first amount of resources, the second amount of resources, and the third amount of resources corresponds to at least one partition of the one or more partitions.

6. The computing system of claim 1, wherein an initial amount of resources that were allocated for performance testing includes an unused amount of resources that were not utilized during performance testing, and wherein the third amount of resources is generated by removing the unused amount of resources from the initial amount of resources.

7. The computing system of claim 6, wherein one or more applications associated with the Kafka platform each include an indicator that indicates whether to remove the unused resources after performance testing has been completed, wherein at least one application of the one or more applications includes a second indicator that indicates that the unused amount of resources is to be removed from the initial amount of resources.

8. The computing system of claim 7, wherein at least one application of the one or more applications includes a second indicator that indicates that the initial amount of resources is to remain unmodified after performance testing has been completed, and wherein the third amount of resources is equivalent to the initial amount of resources.

9. A computerized method for preventing errors from occurring in clusters that are associated with a Kafka platform, the method comprising:
retrieving, by a server computing device, raw resource data from one or more clusters, wherein each cluster of the one or more clusters includes one or more brokers, wherein the raw resource data includes statistical information regarding the one or more clusters;
determining, by the server computing device, for each resource allocated to each cluster of the one or more clusters, utilization rate of the resource, wherein the determination is performed based on the statistical information in the raw resource data retrieved from the one or more clusters;
determining, by the server computing device, for each resource allocated to each cluster of the one or more clusters, whether the utilization rate of the resource exceeds one or more predetermined thresholds corresponding to the resource, wherein the one or more predetermined thresholds are ordered by degrees of urgency;
generating, by the server computing device, a Hypertext Markup Language (HTML) document object that includes a resource table that represents the one or more clusters, wherein the resource table includes, for each resource of each cluster of the one or more clusters, a utilization rate of the resource, wherein, in a case that the utilization rate reaches at least one predetermined threshold, the utilization rate is color-coded in the resource table according to a color corresponding to the maximum predetermined threshold that was reached, and wherein a timestamp is added to metadata of the resource table to indicate when the raw resource data was retrieved; and
displaying, by the server computing device, the resource table on a webpage that has been generated in part by the HTML document object.

10. The computing system of claim 9, wherein, for each resource in each cluster of the one or more clusters, an unused amount of the resource is determined after determining the utilization rate of the resource, the unused amount of the resource being determined based on the utilization rate and a total capacity of the resource.

11. The computing system of claim 10, wherein the information in the resource table in the raw resource data includes, for each cluster of the one or more clusters, number of applications associated with the cluster, a utilization rate of partitions, a utilization rate of connections, a utilization rate of read operations, a utilization rate of write operations, an unused amount of partitions, an unused amount of connections, an unused amount of read operations, and an unused amount of write operations.

12. The computing system of claim 9, wherein the resource table includes a status indicator that indicates the status each cluster of the one or more clusters, wherein the status indicator includes a normal status when the utilization rate of each resource associated with the cluster is less than the corresponding predetermined threshold, and wherein the status indicator includes an alarm status when at least one utilization rate of a resource associated with the cluster reaches at least one of the corresponding one or more predetermined thresholds.

13. The computing system of claim 12, wherein, when a utilization rate of a resource associated with the cluster reaches a first predetermined threshold, the status indicator indicates a warning status, which is an alarm status that is color-coded according to a first color.

14. The computing system of claim 13, wherein, when a utilization rate of a resource associated with the cluster reaches a second predetermined threshold, the status indicator indicates an alert status, which is an alarm status that is color-coded according to a second color, wherein the first color and the second color are different from each other.

15. The computing system of claim 13, wherein updated raw resource data is continuously retrieved from the one or more clusters at a predetermined time interval, such that a new resource table is generated based on the updated raw resource data, and wherein the new resource table is transmitted for display on a webpage.

16. The computing system of claim 9, wherein resources allocated to a cluster includes at least one of partitions, connection capacity, read operation capacity, and write operation capacity.

17. A computerized method for performing configuration during a life cycle development of the Kafka platform to reduce errors during execution, the method comprising:
receiving, by a server computing device, a request, from a user of a producer application, to commence a development process on the Kafka platform, wherein the development process includes one or more stages;
allocating, by the server computing device, based on the request, a cluster, which includes one or more brokers, wherein each message transmitted by the producer application to the cluster is stored in a leading partition on a corresponding broker of the one or more brokers, and wherein the leading partition generates one or more copies of the message to be stored in one or more contingency partitions;
generating, by the server computing device, a Kafka configuration that includes one or more predetermined settings comprising:
a first setting that causes the Kafka platform to register a successful write of a message on the cluster when the Kafka platform receives acknowledgement from the leading partition and at least one replica partition;
a second setting that causes at least one message to be removed from corresponding leader and contingency partitions after an expiration of a predetermined time period, wherein the predetermined time period commences after the at least one message has already been consumed by each consuming application; and
a third setting that manages access control information, wherein the access control information is stored in the Kafka configuration according to a second format and is transformed to a first format when the access control information is requested by the user, the first format being in a human-readable format; and
authorizing, by the server computing device, a progression request to progress the development process to a subsequent stage of the one or more stages when the progression request is transmitted by one or more authorized users, wherein the first setting and the second setting are unmodifiable.

18. The computerized method of claim 17, wherein the request includes a message template that is in the unescaped JavaScript Object Notation (JSON), the message template being associated with a structure of each message produced and consumed on the Kafka platform.

19. The computerized method of claim 17, further comprising:
receiving, by a server computing device, a message template from the user in request, the message template being in an unescaped JavaScript Object Notation (JSON) format;
transforming, by the server computing device, a message template from the unescaped JSON format into an escaped schema format; and
transmitting, by the server computing device, the transformed message template to a schema registry.

20. The computerized method of claim 18, further comprising:
generating, by the server computing device, a subject identifier for the message template based on a topic identifier associated with each message, wherein the user is restricted from modifying the subject identifier.

21. The computerized method of claim 18, further comprising:
transmitting, by the server computing device, the access control information after receiving a request for the access control information from the user, wherein the access control information is transmitted to the user in the second format;
receiving, by the server computing device, a modified access control information from the user, wherein the modified access control information includes one or more modifications to the access control information; and
transforming, by the server computing device, the modified access control information from the second format into the first format.

22. The computerized method of claim 21, wherein the access control information is transmitted to be displayed on a user interface, and wherein the user modifies the access control information to generate the modified access control information via the user interface.

23. The computerized method of claim 18, wherein the access control information corresponds to one or more permissions granted to at least one of the producer application, one or more subjects, and one or more consumer devices.

24. The computerized method of claim 18, wherein the access control information indicates one or more authorized users that are allowed to cause the progression of the development process to progress from one stage to another stage.
